(19) United States
(12) Patent Application Publication
(10) Pub. No.: US 2018/0274504 A1
(43) Pub. Date: Sep. 27, 2018

(54) FUEL TANK AND FUEL SUPPLY SYSTEM

(71) Applicant: DENSO CORPORATION, Kariya-city (JP)

(72) Inventor: Norihiro HAYASHI, Kariya-city (JP)

(21) Appl. No.: 15/910,170

(22) Filed: Mar. 2, 2018

(30) Foreign Application Priority Data
Mar. 23, 2017 (JP) 2017-57237

(51) Int. Cl. F02M 37/10

(52) U.S. Cl. CPC F02M 37/103; G05D 7/0676

(57) ABSTRACT

A holder unit is movably provided in a tank body in such a manner that one end of the holder unit is movably connected to a rotation supporting portion formed on a bottom wall of the tank body. A manual lever is connected to the other end of the holder unit. When the manual lever is pulled up, the holder unit is rotated around the rotation supporting portion, so that the other end is located in an entrance space formed at a position adjacent to a tank opening. A pump module is inserted into the tank body through the tank opening and attached to the holder unit. Then, the holder unit is pushed down by the manual lever to a pump installation position, in which the other end of the holder unit is located in an installation space formed on the bottom wall. The holder unit is engaged with a holding portion formed in the tank body, so that the holder unit and the pump module are stably held at the pump installation position.

### CROSS REFERENCE TO RELATED APPLICATION

This application is based on Japanese Patent Application No. 2017-57237 filed on Mar. 23, 2017, the disclosure of which is incorporated herein by reference.

### FIELD OF TECHNOLOGY

The present disclosure relates to a fuel tank and a fuel supply system using the same for an automotive vehicle.

### BACKGROUND

A fuel supply system of an in-tank type is known in the art, wherein a pump module is installed in a fuel tank of an automotive vehicle. For example, in a fuel supply system, as disclosed in Japanese Patent Publication No. 2016-121555, a pump module is installed on a bottom wall of a fuel tank.

In the fuel supply system of the above prior art, the pump module is firmly attached to a holder unit having a rotational shaft. A sub tank, which is provided in a tank body, has a pair of side walls, wherein a shaft supporting recess is formed in each of the side walls. When the pump module is installed in the tank body, the pump body is inserted into the tank body through a tank opening formed at an upper-side wall of the tank body so as to engage the rotational shaft of the pump module to the shaft supporting recesses of the sub tank. Then, the pump module is rotated around the rotational shaft to a predetermined position in order to stably hold the pump module in the tank body. Since the shaft supporting recesses are located in the tank body and at a position remote from the tank opening, it is not always possible to easily and visually confirm the position of the shaft supporting recesses through the tank opening. In other words, it is not always possible to easily install the pump module in the tank body.

### SUMMARY OF THE DISCLOSURE

The present disclosure is made in view of the above problem. It is an object of the present disclosure to provide a fuel tank and a fuel supply system of an in-tank type, according to which a pump module can be easily installed in the fuel tank.

According to one of features of the present disclosure, a fuel tank accommodates a pump module and stores fuel which is discharged by the pump module to an outside of the fuel tank. The fuel tank has a tank body, a holder unit and a holding portion. The tank body, which accommodates therein the pump module and stores the fuel, has a tank opening. The holder unit is movably provided in the tank body. The pump module is attached to the holder unit. The holding portion is formed at an inner wall (a bottom wall) of the tank body. The holding portion stably holds the holder unit and/or the pump module at a predetermined position (an installation position) in the tank body, when the holding portion is engaged with the holder unit or the pump module. The pump module is thereby surely held at its installation position in the tank body.

Since the holder unit is movably provided in the tank body, it is possible to easily and visually confirm a position and a condition of the holder unit in the tank body through the tank opening, when at least a portion of the holder unit is moved to a position in an entrance space, which is defined as a space adjacent to the tank opening. It is thereby possible to smoothly attach the pump module to the holder unit. It is further possible to install the pump module at the predetermined position in the tank body, when the holder unit is moved together with the pump module to the installation position at which the holder unit is engaged with the holding portion. As above, it is possible to easily install the pump module in the tank body.

According to another feature of the present disclosure, the fuel tank accommodates the pump module and stores the fuel to be discharged by the pump module to the outside of the fuel tank. The fuel tank has the tank body, the holding portion and a guide member. The tank body, which accommodates therein the pump module and stores the fuel, has the tank opening. The holding portion is formed in the inner wall (the bottom wall) of the tank body and stably holds the pump module, when the holding portion is engaged with the pump module. It is thereby possible to stabilize a position of the pump module in the tank body.

The guide member is provided in the tank body and movably engaged with the pump module so as to guide a movement of the pump module. When one of portions of the guide member is located at a position in the entrance space formed adjacent to the tank opening, it is possible to visually confirm the position of the guide member through the tank opening. Therefore, it is possible to easily engage the pump module with the guide member. When the pump module is moved along the guide member, it is possible to locate the pump module at the predetermined position in the tank body. In other words, it is possible to easily install the pump module at the installation position in the tank body.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a fuel tank and a fuel supply system of an in-tank type according to a first embodiment of the present disclosure;

FIG. 2 is a schematic top plane view showing a holder unit and a pump module of the fuel supply system according to the first embodiment, when viewed it in a vertical direction from a top side;

FIG. 3 is a schematic view for explaining a step of installing the pump module of the fuel supply system at a predetermined position in a tank body;

FIG. 4 is another schematic view for explaining the step of installing the pump module of the fuel supply system into the tank body, wherein the pump module is rotated and moved to the predetermined position;

FIG. 5 is a further schematic view for explaining the step of installing the pump module of the fuel supply system into the tank body, wherein the pump module is located at the predetermined position;

FIG. 6 is a schematic view showing a condition that the pump module of the fuel supply system is installed in the tank body;

FIG. 7 is a schematic view for explaining a step of installing a pump module of a fuel supply system of a second embodiment to a predetermined position in a tank body;

FIG. 8 is another schematic view for explaining the step of installing the pump module of the fuel supply system in the tank body, wherein the pump module is located at the predetermined position;

FIG. 9 is a schematic view showing a condition that a holder unit is disengaged from a holding portion;

FIG. 10 is a schematic top plane view showing a holder unit and a pump module of a fuel supply system according to a third embodiment, when viewed it in a vertical direction from a top side;

FIG. 11 is a schematic view for explaining a step of installing the pump module of the fuel supply system to a predetermined position in a tank body;

FIG. 12 is another schematic view for explaining the step of installing the pump module of the fuel supply system in the tank body;

FIG. 13 is a further schematic view for explaining the step of installing the pump module of the fuel supply system in the tank body, wherein the pump module is moved to the predetermined position;

FIG. 14 is a schematic view for explaining a step of installing a pump module of a fuel supply system according to a fourth embodiment into the tank body;

FIG. 15 is another schematic view for explaining the step of installing the pump module of the fuel supply system, wherein the pump module is moved to the predetermined position in the tank body;

FIG. 16 is a schematic view showing a condition that a holder unit is disengaged from a holding portion;

FIG. 17 is a schematic view for explaining a step of installing a pump module of a fuel supply system according to a fifth embodiment into the tank body;

FIG. 18 is another schematic view for explaining the step of installing the pump module of the fuel supply system into the tank body;

FIG. 19 is a further schematic view for explaining the step of installing the pump module of the fuel supply system, wherein the pump module is moved to a predetermined position in the tank body;

FIG. 20 is a schematic top plane view showing a holder unit and a pump module of a fuel supply system according to a sixth embodiment, when viewed it in a vertical direction from a top side;

FIG. 21 is a schematic view for explaining a step of installing the pump module of the fuel supply system into the tank body;

FIG. 22 is another schematic view for explaining the step of installing the pump module of the fuel supply system, wherein the pump module is moved to a predetermined position in the tank body;

FIG. 23 is a further schematic view for explaining the step of installing the pump module of the fuel supply system, wherein the pump module is moved to the predetermined position in the tank body;

FIG. 24 is a schematic top plane view showing a holder unit and a pump module of a fuel supply system according to a seventh embodiment, when viewed it in a vertical direction from a top side;

FIG. 25 is a schematic view for explaining a step of installing the pump module of the fuel supply system, wherein the pump module is moved to a predetermined position in the tank body;

FIG. 26 is a schematic cross sectional view taken along a line XXVI-XXVI in FIG. 25 and showing a portion of the fuel supply system, wherein a holder unit is engaged with a holding portion; and

FIG. 27 is a schematic view showing a portion of the fuel supply system according to an eighth embodiment, wherein FIG. 27 shows a holder unit and its related parts.

### DETAILED DESCRIPTION OF THE EMBODIMENTS

A fuel tank and a fuel supply system of the present disclosure will be explained hereinafter byway of multiple embodiments and/or modifications with reference to the drawings. The same reference numerals are given to the same or similar parts or portions throughout the multiple embodiments and/or modifications in order to eliminate repeated explanation.

### First Embodiment

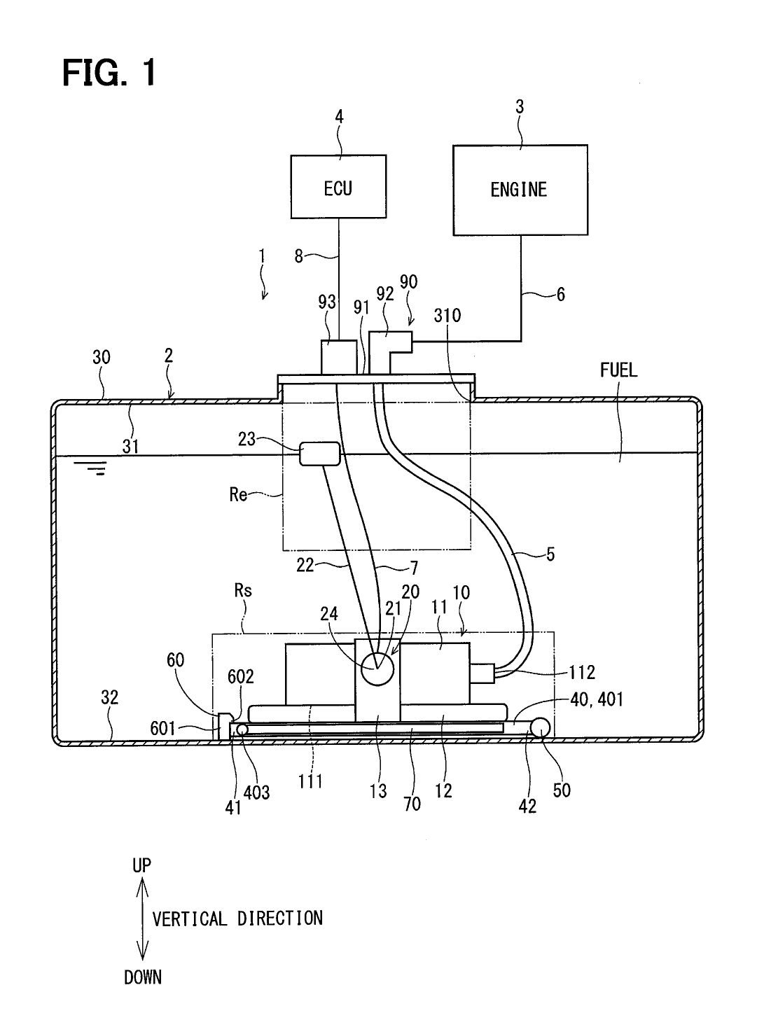

A fuel tank 2 and a fuel supply system 1 according to a first embodiment of the present disclosure are shown in FIG. 1. The fuel supply system 1 is mounted to an automotive vehicle (not shown) together with an internal combustion engine 3 (hereinafter, the engine 3). The fuel supply system 1 is composed of the fuel tank 2, a pump module 10, a sender gage 20 and so on. The fuel supply system 1 supplies fuel stored in the fuel tank 2 to the engine 3.

The fuel tank 2 is composed of a tank body 30, a holder unit 40, a rotation supporting portion 50, a holding portion 60, a manual lever 70 and so on.

The tank body 30 is made of, for example, metal and formed in a box shape forming an inside space therein. The tank body 30 has a top wall 31, a bottom wall 32, a tank opening 310, and so on. The top wall 31 is a wall of the fuel tank 2, which is located at an upper side in a vertical direction, in a condition that the tank body 30 is mounted to the automotive vehicle. The bottom wall 32 is a wall of the fuel tank 2, which is located at a lower side in the vertical direction, in the condition that the tank body 30 is mounted to the automotive vehicle. In other words, the bottom wall 32 is opposed to the top wall 31 in the vertical direction. The tank opening 310 is formed in the top wall 31 so as to pass through the top wall 31. Therefore, the tank opening 310 communicates the inside space of the tank body 30 to an outside thereof. The tank opening 310 is formed in an almost circular shape. The fuel is stored in the inside space of the tank body 30.

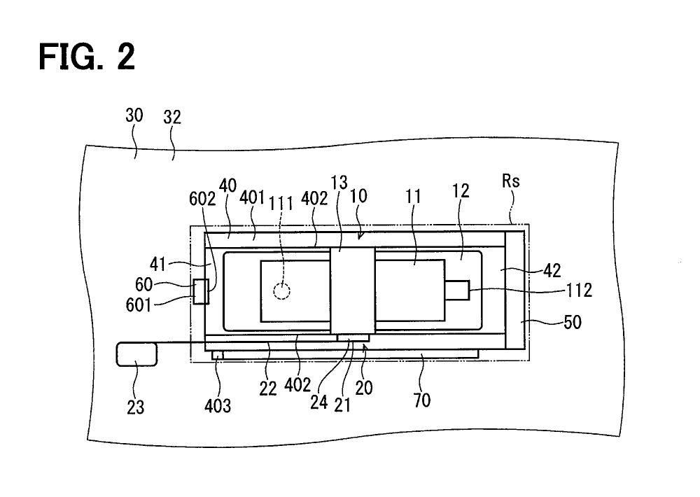

The holder unit 40 is movably provided in the tank body 30. The holder unit 40 has a holder body 401, a pair of holder grooves 402, a rotation supporting projection 403, and so on. The holder body 401 is made of, for example, resin and formed in a rectangular plate shape. Each of the holder grooves 402 is formed on one of plate surfaces (an upper side surface) of the holder body 401 and extends in a longitudinal direction of the holder body 401. In the present embodiment, each of the holder grooves 402 is so formed as to be parallel to each other (FIG. 2). The rotation supporting projection 403 is formed in the holder body 401 at one of longitudinal ends (a left-hand end 41) so as to be projected from a side surface of the holder body 401 in a short-side direction (a direction perpendicular to the longitudinal direction).

The rotation supporting portion 50 is formed in the tank body 30 at the bottom wall 32. The rotational supporting portion 50 is connected to the other longitudinal end of the holder body 401 (a right-hand end 42) opposite to the left-hand end 41. The rotation supporting portion 50 movably supports the holder body 401 in such a way that the holder body 401 can be rotated at the rotation supporting portion 50. The holder body 401 is accommodated in the tank body 30 in a condition that the right-hand end 42 of the holder body 401 is movably connected to the rotation supporting portion 50. The holder unit 40 is rotatable around the rotation supporting portion 50. In other words, the holder unit 40 is rotatable in such a way that the left-hand end 41 of the holder body 401 traces a circular arc between a position neighboring to the bottom wall 32 and a position adjacent to the tank opening 310 (FIG. 1 and FIGS. 3 to 6). The left-hand end 41 of the holder body 401 is also referred to as a movable end 41.

The holding portion 60 is provided at the bottom wall 32 in the tank body 30. The holding portion 60 has a supporting body 601 and a fitting claw 602. The supporting body 601 extends in the vertical direction from a predetermined position of the bottom wall 32. The fitting claw 602 is formed at an upper-side end of the supporting body 601 and projected in a surface direction parallel to the bottom wall 32, that is, in a horizontal direction. A lower-side surface of the fitting claw 602 is formed with a flat surface, which is parallel to the bottom wall 32. An upper-side surface of the fitting claw 602 is formed with a flat surface, which is inclined with respect to the bottom wall 32 in such a way that a height of the upper-side surface (a vertical distance between the upper-side and the lower-side surfaces) is decreased in a direction from the supporting body 601 to a projected forward end of the fitting claw 602, for example, as shown in FIG. 1.

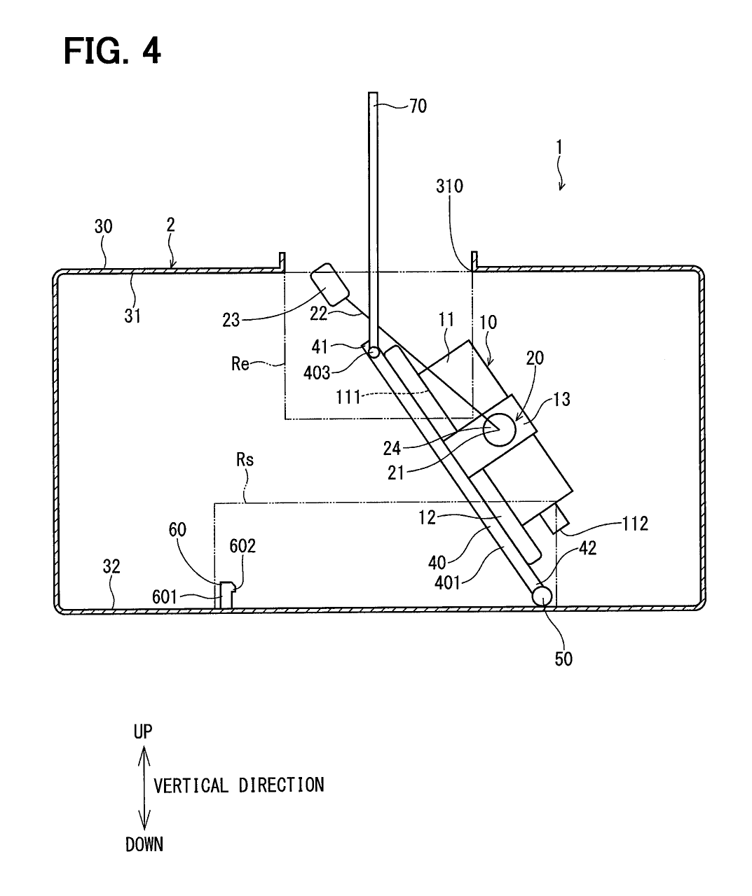

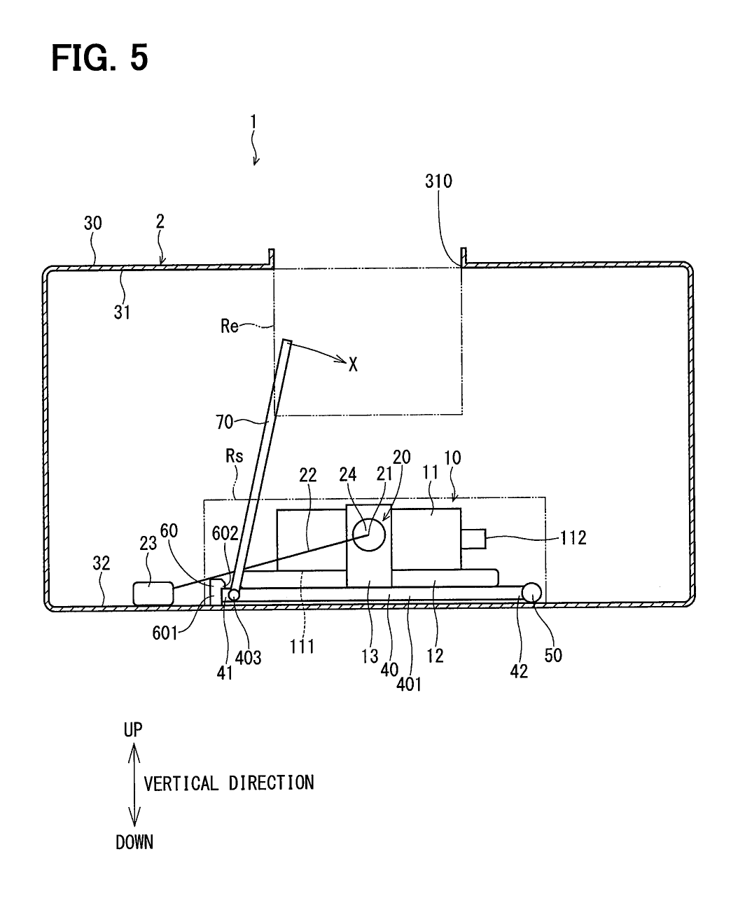

The fitting claw 602 of the holding portion 60 is so formed that the fitting claw 602 is operatively fitted to the movable end 41 of the holder unit 40. When the holding portion 60 is fitted to (engaged with) the holder unit 40, the lower-side surface of the fitting claw 602 is in contact with an upper-side surface of the movable end 41 of the holder body 401. When the holder unit 40 is rotated about the rotation supporting portion 50, for example, from a position of FIG. 4 to a position of FIG. 5, the movable end 41 is moved in a direction closer to the bottom wall 32 and the movable end 41 is brought into contact with the upper-side surface of the fitting claw 602. When the movable end 41 is further moved in the direction closer to the bottom wall 32, the supporting body 601 is elastically deformed and thereby the movable end 41 can move to a side of the lower-side surface of the fitting claw 602. Accordingly, the holder unit 40 is engaged with the holding portion 60. As above, the movable end 41 of the holder unit 40 is engaged with the holding portion 60 by, so called, a snap-fit action.

The manual lever 70 is formed in a straight bar shape. One end of the manual lever 70 (a left-hand end in FIG. 1) is movably connected to the rotation supporting projection 403 of the holder unit 40, so that the manual lever 70 is rotatable at the rotation supporting projection 403. In the condition that the holder unit 40 is engaged with the holding portion 60, the other end of the manual lever 70 (a right-hand end in FIG. 1) is moved in such a way that the right-hand end of the manual lever 70 traces a circular arc between a position neighboring to the bottom wall 32 and a position adjacent to the tank opening 310 (FIG. 1 and FIGS. 5 to 6). The right-hand end of the manual lever 70 is also referred to as a grip end.

The pump module 10 is attached to the holder unit 40. The pump module 10 is composed of a fuel pump 11, a fuel filter 12, a pump attaching member 13 and so on. The fuel pump 11 is formed in an almost cylindrical shape. The fuel pump 11 is composed of an electric motor (not shown), an impeller (not shown) rotated by the electric motor and so on. When electric power is supplied to the electric motor so as to rotate the impeller, the fuel is sucked into a pump chamber via a suction port 111 and pressurized in an inside of the fuel pump. The pressurized fuel is pumped out from a discharge port 112. An axial length of the pump module 10 is larger than an inner diameter of the tank opening 310 of the tank body 30.

The fuel filter 12 is made of nonwoven fabric cloth and formed in a rectangular flat shape. One of flat side surfaces of the fuel filter 12 is connected to the suction port 111 of the fuel pump 11. The fuel filter 12 is integrally connected to the fuel pump 11 in such a way that a longitudinal direction of the fuel filter 12 is in parallel to an axial direction of the fuel pump 11. When the fuel pump 11 draws the fuel via the suction port 111, the fuel passes through the fuel filter 12 so that extraneous material contained in the fuel is trapped and removed from the fuel. A longitudinal length of the fuel filter 12 is likewise larger than the inner diameter of the tank opening 310 of the tank body 30.

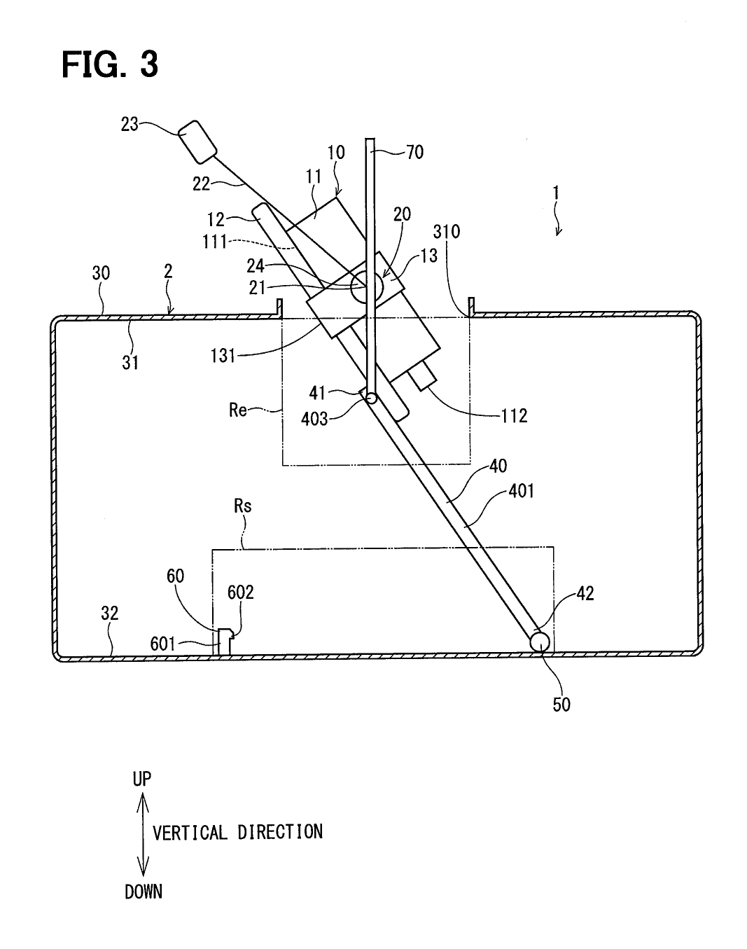

The pump attaching member 13 is fixed to a middle portion of the fuel pump 11 for attaching the fuel pump 11 and the fuel filter 12 to the holder body 401. The pump attaching member 13 has a pair of fitting projections 131 at a lower side thereof (FIG. 3). Each of the fitting projections 131 is inserted into the respective holder groove 402 of the holder unit 40. In a condition that the fitting projections 131 are respectively inserted into the holder grooves 402, the pump module 10 is movable relative to the holder unit 40 in the axial direction of the fuel pump 11, in which each of the holder grooves 402 straightly extends. When the pump module 10 is attached to the holder unit 40 by the engagement between the fitting projections 131 and the holder grooves 402, a movement of the pump module 10 is restricted in a direction away from the holder unit 40, that is, in a direction perpendicular to the upper-side surface of the holder body 401.

The sender gage 20 is composed of a rotation center portion 21, an arm member 22, a float member 23, a detection unit 24 and soon. The rotation center portion 21 is formed in the pump attaching member 13 of the pump module 10. The arm member 22 is formed in a bar shape extending from the rotation center portion 21 so that the arm member 22 is rotatable about the rotation center portion 21. The float member 23 is connected to a forward end of the arm member 22, which is opposite to the rotation center portion 21. The float member 23 is so formed that a buoyant force is generated in the fuel. The detection unit 24 is provided at the rotation center portion 21 so as to detect a rotational position of the arm member 22.

The float member 23 is movable in the tank body 30 in the vertical direction depending on an amount of the fuel in the tank body 30 and thereby the arm member 22 is rotated about the rotation center portion 21, in a condition that the pump module 10 is fixed to the holder unit 40, the holder unit 40 is engaged with the holding portion 60 and the pump module 10 is installed in the tank body 30. The detection unit 24 outputs a detection signal depending on the rotational position of the arm member 22 to an electronic control unit 4 (hereinafter, the ECU 4).

The ECU 4 is composed of a micro-computer including CPU as a calculation portion, ROM, RAM and EEPROM as memory devices, I/O as an input-output portion, and so on. The ECU 4 carries out various kinds of calculations in accordance with programs stored in the ROM or the like, and based on information including signals from various kinds of sensors mounted in the automotive vehicle. The ECU 4 controls operations of various kinds of electronic devices and/or components of the automotive vehicle. The ECU 4 detects the amount of the fuel in the tank body 30 based on the detection signal from the detection unit 24. In addition, the ECU 4 controls an amount of the fuel to be discharged from the pump module 10 by controlling the electric power supply to the electric motor of the fuel pump 11.

As shown in FIG. 1, a flange unit 90 is attached to the fuel tank 2. The flange unit 90 is composed of a flange body 91, a discharge pipe 92, a connector 93 and so on. The flange body 91 is made of, for example, resin and formed in a circular plate shape. The flange body 91 is attached to the tank body 30 so as to close the tank opening 310. The discharge pipe 92 is formed in a cylindrical shape, which is outwardly projected from the flange body 91 in a direction opposite to the tank body 30. The discharge pipe 92 communicates an inside and an outside of the tank body 30 with each other. The discharge port 112 of the fuel pump 11 is connected to the discharge pipe 92 via a discharge hose 5. The discharge pipe 92 is connected to the engine 3 via a fuel pipe 6. According to the above structure, the fuel discharged from the fuel pump 11 is supplied to the engine 3 via the discharge hose 5, the discharge pipe 92 and the fuel pipe 6.

The connector 93 is likewise so formed as to be outwardly projected from the flange body 91 in the direction opposite to the tank body 30. The connector 93 is respectively connected to the electric motor of the fuel pump 11 and the detection unit 24 of the sender gage 20 via a wire 7. The connector 93 is further connected to the ECU 4 via a wire 8. According to the above structure, the ECU 4 can control the electric power supply to the electric motor of the fuel pump 11 via the wires 7 and 8. In addition, the detection unit 24 transmits the detection signal to the ECU 4 via the wires 7 and 8.

As shown in FIGS. 1 to 3, an installation space “Rs” and an entrance space “Re” are respectively defined in the tank body 30. The installation space “Rs” is defined as a space formed in a predetermined three dimensional area on the bottom wall 32 of the tank body 30.

In the present embodiment, the installation space “Rs” is formed at a position directly below the tank opening 310. As shown in FIG. 1, the holder unit 40 and the pump module 10 are located in the installation space “Rs”, when the pump module 10 is fixed to the holder unit 40 and the holder unit 40 is engaged with the holding portion 60. In the present embodiment, as shown in FIGS. 1 and 2, the installation space “Rs” is a cubic space, which has such a size that all of the holder unit 40, the pump module 10, the rotation supporting portion 50, the holding portion 60 and the manual lever 70 are included in the installation space “Rs”. Therefore, as shown in FIG. 1, a height of the installation space “Rs” from the bottom wall 32 is larger than a height of the pump module 10 from the bottom wall 32, in a condition that the holder unit 40 is engaged with the holding portion 60.

The entrance space “Re” is defined as a space formed in a predetermined three dimensional area from the tank opening 310, namely at a position adjacent to the tank opening 310 in the tank body 30. The entrance space “Re” is defined as a columnar space, which extends in a vertical-downward direction from the tank opening 310. In the present embodiment, a depth of the entrance space “Re” from the tank opening 310 to a lower end of the entrance space “Re” in the vertical-downward direction, that is, a size of the entrance space “Re” in the vertical direction, is larger than a radius of the tank opening 310 but smaller than a diameter thereof. Therefore, it is possible to easily and visually confirm positions and conditions of the parts of the pump module 10 and so on from an outside of the tank body 30 through the tank opening 310, when those parts are located in the entrance space “Re”. In the present embodiment, at least a part of the holder unit 40 (for example, the movable end 41) is movable between the entrance space “Re” and the installation space “Rs” in the tank body 30.

A step for installing the pump module 10 into the tank body 30 will be explained.

(Step for pulling up the holder unit)

As shown in FIG. 3, the grip end of the manual lever 70 (the right-hand end in FIG. 1) is caught by a worker and the movable end 41 of the holder unit 40 is pulled up in the vertical direction. As a result, the movable end 41 of the holder unit 40 is moved to a position in the entrance space “Re”.

(Step for attaching the pump module to the holder unit)

As shown in FIG. 3, the fitting projections 131 of the pump module 10 are inserted into the holder grooves 402 of the holder unit 40 in order to attach the pump module 10 to the holder unit 40, while the holder grooves 402 are visually confirmed by the worker through the tank opening 310. Then, as shown in FIGS. 3 and 4, the pump module 10 is moved by the worker relative to the holder unit 40 in the direction of the holder grooves 402, in a condition that the fitting projections 131 are inserted into the holder grooves 402. As a result, the pump module 10 is fixed to a predetermined position of the holder unit 40, as shown in FIG. 4.

(Step for rotating the holder unit & Step for fitting the holder unit to the tank body)

As shown in FIGS. 4 and 5, the holder unit 40 is rotated by the worker in a direction that the movable end 41 of the holder unit 40 comes closer to the bottom wall 32, that is, in an anti-clockwise direction in FIG. 4, while the grip end of the manual lever 70 is continuously caught by the worker. Then, the holder unit 40 is engaged with the holding portion 60, as shown in FIG. 5. In this situation, the holder unit 40 and the pump module 10 are located at a predetermined position in the installation space “Rs”. The worker can easily confirm whether the holder unit 40 is surely engaged with the holding portion 60 or not by pulling up the manual lever 70 in the vertical-upward direction. If the manual lever 70 cannot be easily pulled up, the holder unit 40 is in the condition that it is surely engaged with the holding portion 60.

(Step for returning the manual lever to its initial position)

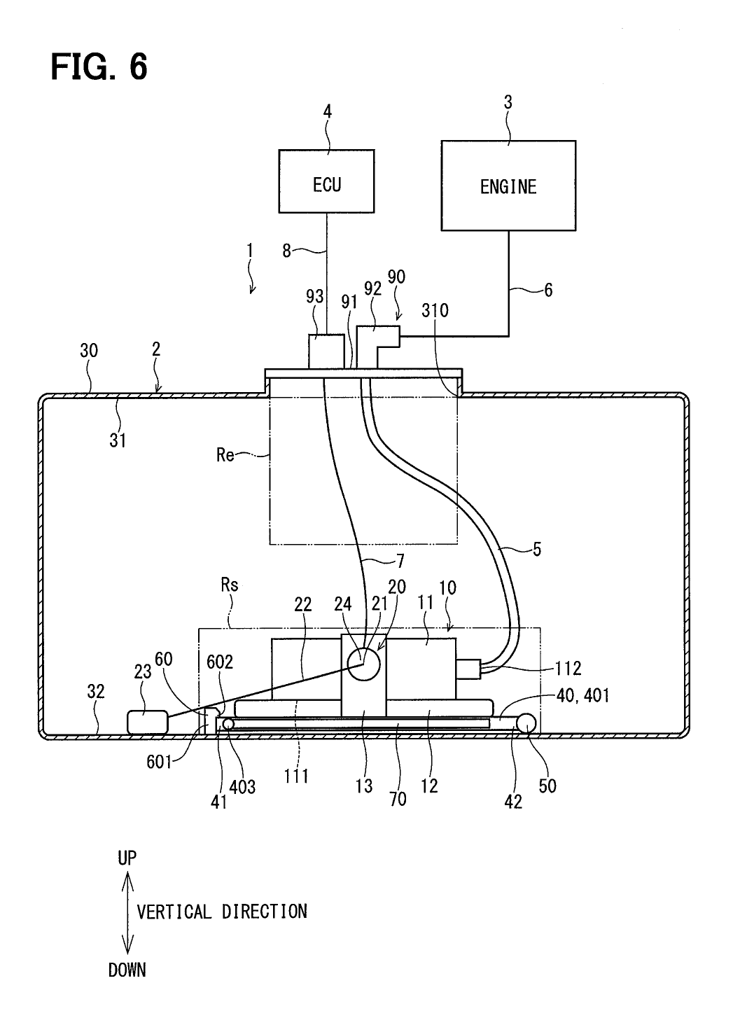

As shown in FIGS. 5 and 6, the grip end of the manual lever 70 is rotated in a direction “X” (a clockwise direction) by the worker, so that the grip end comes closer to the rotation supporting portion 50. As a result, the manual lever 70 is returned to its initial position, in which the axial direction of the manual lever 70 coincides with the longitudinal direction of the holder unit 40.

(Step for fixing the flange unit to the tank body)

As shown in FIG. 6, the flange unit 90 is fixed to the tank body 30 so as to close the tank opening 310 by the flange body 91, in a condition that the discharge port 112 of the fuel pump 11 is connected to the discharge pipe 92 of the flange unit 90 via the discharge hose 5 and that the detection unit 24 of the sender gage 20 is connected to the connector 93 of the flange unit 90 via the wire 7.

As shown in FIG. 6, the arm member 22 of the sender gage 20 extends from the rotation center portion 21 in the direction opposite to the rotation supporting portion 50, when the pump module 10 is attached to the holder unit 40, the holder unit 40 is engaged with the holding portion 60 and there is no fuel in the tank body 30. On the other hand, as shown in FIG. 1, the arm member 22 is rotated to a predetermined position corresponding to a fuel filled-up condition, in which the fuel is fully filled in the tank body 30.

The movable end 41 of the holder unit 40 is unexpectedly separated from the bottom wall 32, when the holder unit 40 is disengaged from the holding portion 60 during an operation of the fuel supply system 1. When the tank body 30 is filled up with the fuel in the condition that the movable end 41 of the holder unit 40 is separated from the bottom wall 32, the ECU 4 determines that the tank body 30 is not yet filled up with the fuel, in spite of the fuel filled-up condition, because the arm member 22 is located at a rotational position different from the predetermined position for the fuel filled-up condition of the tank body 30. Accordingly, it is possible to detect that the holder unit 40 is unexpectedly disengaged from the holding portion 60.

As explained above, in the present embodiment, the fuel tank 2 accommodates the pump module 10 and stores the fuel, which is discharged by the pump module 10 to the outside of the fuel tank 2. The fuel tank 2 includes the tank body 30, the holder unit 40 and the holding portion 60. The tank body 30 accommodates the pump module 10 and has the tank opening 310. The tank body 30 stores the fuel therein. The holder unit 40 is movably provided in the tank body 30 so as to support the pump module 10. The holding portion 60 is formed at an inner wall (the bottom wall 32) of the tank body 30. When the holding portion 60 is engaged with the holder unit 40, the holder unit 40 is firmly attached to the tank body 30. Accordingly, the position of the pump module 10 in the tank body 30 can be stably maintained.

In the present embodiment, the holder unit 40 is movably provided in the tank body 30. It is therefore possible to visually confirm the position and the condition of the holder unit 40 through the tank opening 310, when at least a part of the holder unit 40 (for example, the movable end 41) is moved to the position located in the entrance space “Re”, which is formed at the position adjacent to the tank opening 310. It is thereby possible to easily attach the pump module 10 to the holder unit 40. It is further possible to locate the pump module 10 at the predetermined position (the installation space “Rs”) in the tank body 30, when the holder unit 40 is rotated and moved to the position, at which the holder unit 40 is engaged with the holding portion 60. As above, it is possible to easily install the pump module 10 in the tank body 30.

In addition, in the present embodiment, the rotation supporting portion 50 is provided in the tank body 30. The rotation supporting portion 50 is provided at a position adjacent to the right-hand end 42 of the holder unit 40 for movably supporting the rotational movement of the holder unit 40. It is possible to move the movable end 41 of the holder unit 40 to the position located in the entrance space “Re” formed at the position adjacent to the tank opening 310, when the holder unit 40 is rotated in the tank body 30 about the rotation supporting portion 50. It is therefore possible to easily and visually confirm the position and the condition of the holder unit 40 through the tank opening 310. As a result, it is possible to easily install the pump module 10 in the tank body 30.

In the present embodiment, the manual lever 70 is further provided. One end of the manual lever 70 is connected to the holder unit 40 in such away that the other end (the grip end) of the manual lever 70 can be moved to the position adjacent to the tank opening 310, in the condition that the holder unit 40 and the pump module 10 are installed in the installation space “Rs”. According to the above structure, it is possible to move the part (the movable end 41) of the holder unit 40 to the position located in the entrance space “Re”, when the grip end of the manual lever 70 is pulled up. In addition, it is further possible to easily engage the holder unit 40 with the holding portion 60, when the grip end of the manual lever 70 is pushed down.

In addition, the manual lever 70 is provided in the tank body 30 in such a way that the manual lever 70 is rotatable around one end thereof opposite to the grip end. It is therefore possible to easily pick up the grip end of the manual lever 70, when rotating the manual lever 70 so as to move the grip end to the position adjacent to the tank opening 310. Furthermore, it is possible to return the manual lever 70 to its initial position by rotating the same, after the holder unit 40 is engaged with the holding portion 60. Since the initial position of the manual lever 70 is parallel to the holder unit 40, it is possible to prevent the manual lever 70 from harming a smooth movement of the arm member 22 of the sender gage 20.

In the present embodiment, the fuel supply system 1 includes the fuel tank 2 and the pump module 10 accommodated in the fuel tank 2. The pump module 10 can be easily installed in the tank body 30.

In the present embodiment, the sender gage 20 is provided. The sender gage 20 includes the rotation center portion 21 connected to the pump module 10, the arm member 22 extending from the rotation center portion 21 and rotatable around the rotation center portion 21, the float member 23 provided at one end of the arm member 22 opposite to the rotation center portion 21, and the detection unit 24 for detecting the rotational position of the arm member 22. According to the above structure, it is possible to detect the amount of the fuel in the tank body 30 based on the detection signal from the detection unit 24.

### Second Embodiment

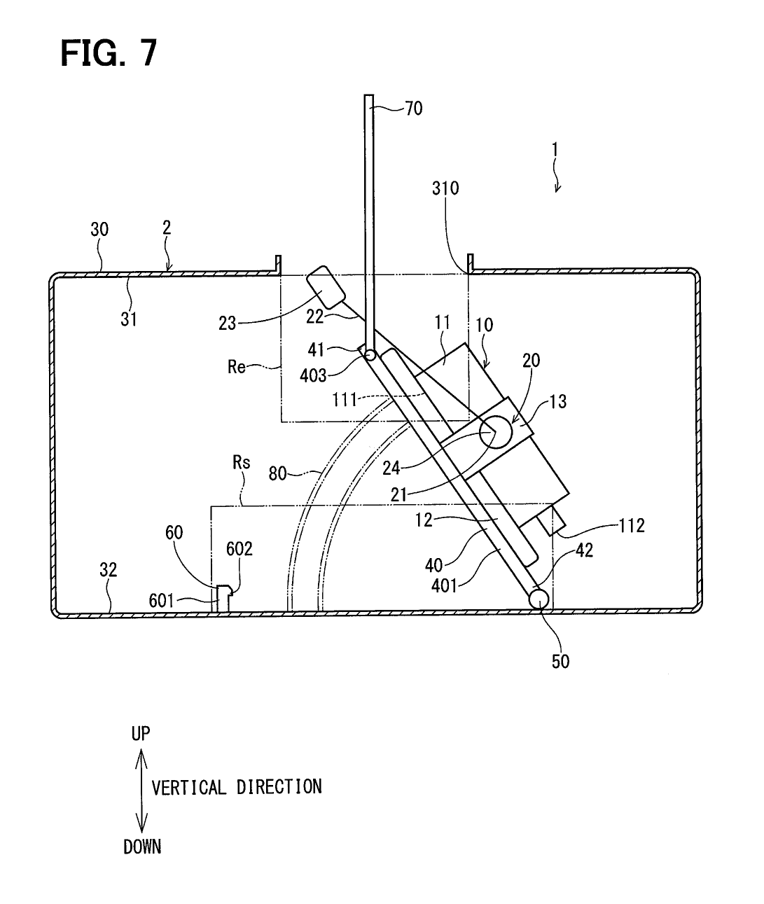

The fuel tank 2 and the fuel supply system 1 according to a second embodiment are shown in FIGS. 7 to 9.

In the second embodiment, a spring 80, for example, a coil spring is provided in the tank body 30 as a biasing member. One end of the spring 80 is connected to a lower-side surface of the holder body 401 of the holder unit 40 (a surface on a side closer to the bottom wall 32 of the tank body 30). The other end of the spring 80 is connected to the bottom wall 32. The spring 80 has a force for expanding the same in its axial direction. The spring 80 can bias the movable end 41 of the holder unit 40 in the direction from the installation space “Rs” to the entrance space “Re”. Therefore, the movable end 41 of the holder unit 40 is moved to and located in the entrance space “Re”, when the holder unit 40 is not engaged with the holding portion 60, as shown in FIG. 7.

A step for installing the pump module 10 into the tank body 30 will be explained.

(Step for attaching the pump module to the holder unit)

In the same manner to the first embodiment, the pump module 10 is attached to the holder unit 40. More exactly, as shown in FIG. 7, the fitting projections 131 (FIG. 3) of the pump module 10 are inserted into the holder grooves 402 (FIG. 2) of the holder unit 40 in order to attach the pump module 10 to the holder unit 40, while the holder grooves 402 are visually confirmed by the worker through the tank opening 310. Then, the pump module 10 is moved by the worker to the predetermined position of the holder unit 40 along the holder grooves 402, in the condition that the fitting projections 131 are inserted into the holder grooves 402. As a result, the pump module 10 is fixed to the predetermined position of the holder unit 40, as shown in FIG. 7.

(Step for rotating the holder unit & Step for fitting the holder unit to the tank body)

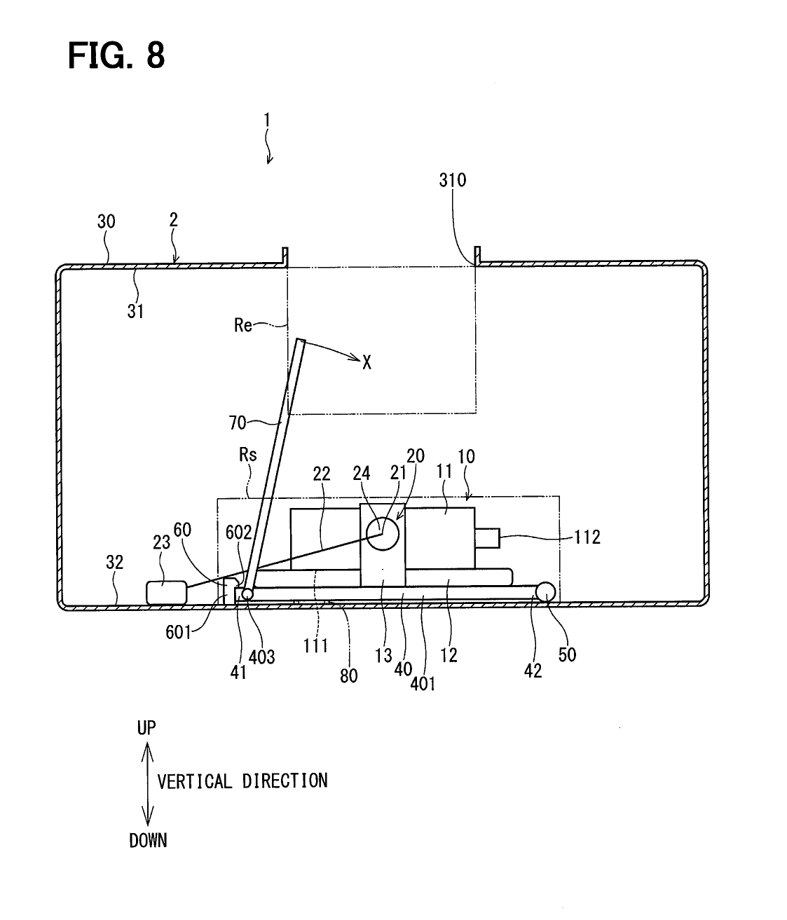

In a similar manner to the first embodiment, the holder unit 40 is rotated and engaged with the holding portion 60. More exactly, as shown in FIGS. 7 and 8, the holder unit 40 is rotated by the worker against a biasing force of the spring 80 in such a direction that the movable end 41 of the holder unit 40 comes closer to the bottom wall 32, that is, in the anti-clockwise direction in FIG. 7, while the grip end of the manual lever 70 is continuously caught by the worker. Then, the holder unit 40 is engaged with the holding portion 60, as shown in FIG. 8. In this situation, the holder unit 40 and the pump module 10 are located in the installation space “Rs”. The worker can easily confirm that the holder unit 40 is not surely engaged with the holding portion 60, if the holder unit 40 is returned to the position of FIG. 7 by the biasing force of the spring 80.

The step for returning the manual lever 70 to its initial position as well as the step for fixing the flange unit 90 to the tank body 30 is the same to those of the first embodiment. The explanation thereof is therefore omitted.

In the present embodiment, the movable end 41 of the holder unit 40 is located in the entrance space “Re” by the biasing force of the spring 80, when the holder unit 40 is not engaged with the holding portion 60. Therefore, the step of the first embodiment for pulling up the holder unit 40 is not necessary in the present embodiment, when the pump module 10 is attached to the holder unit 40.

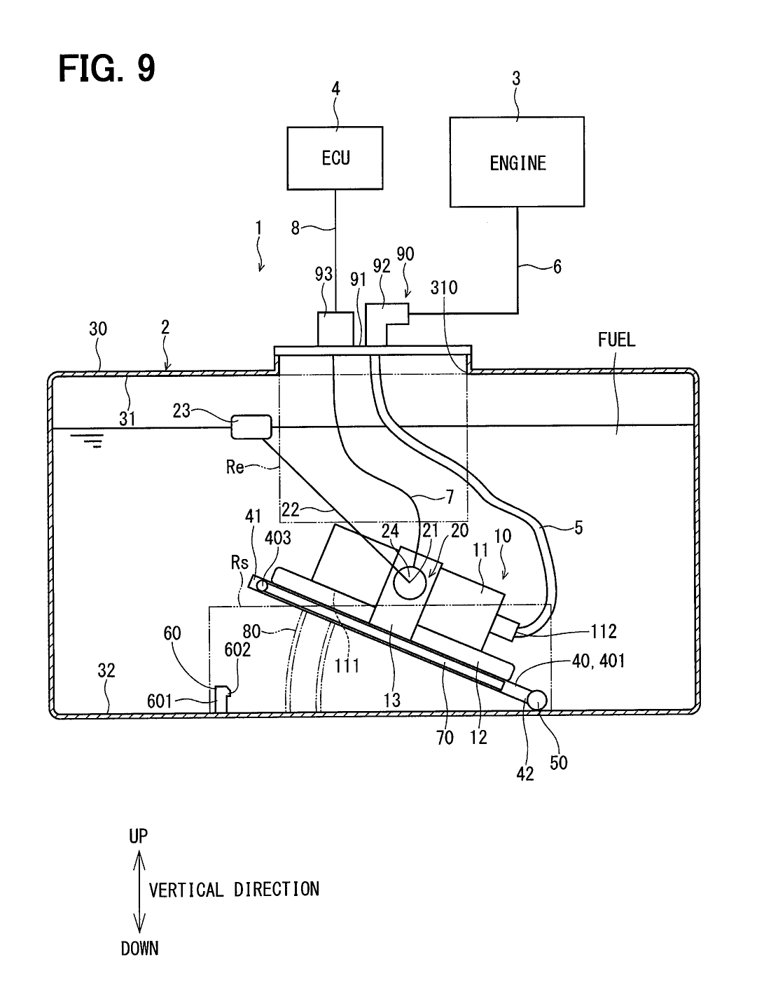

In addition, the movable end 41 of the holder unit 40 is moved by the biasing force of the spring 80 in the clockwise direction to a position closer to the tank opening 310, which is separated from the bottom wall 32 by a predetermined distance, if the holder unit 40 is disengaged from the holding portion 60 during the operation of the fuel supply system 1. When the tank body 30 is filled up with the fuel in the above situation (that is, in the situation that the holder unit 40 is disengaged from the holding portion 60), the arm member 22 is moved to and located at a rotational position different from the predetermined position for the fuel filled-up condition of the tank body 30, as shown in FIG. 9. Therefore, the ECU 4 determines that the tank body 30 is not yet filled up with the fuel, in spite of the fuel filled-up condition. In other words, a vehicle driver can determine that the holder unit 40 is disengaged from the holding portion 60 or at least can determine that something is wrong, when the determination of the ECU 4 (the indication of not filled-up condition) is informed to the vehicle driver via a display or the like.

As explained above, the spring 80 is provided in the present embodiment. The spring 80 biases the holder unit 40 in the direction that the movable end 41 of the holder unit 40 is moved from the installation space “Rs” to the entrance space “Re”. The installation space “Rs” is defined as the space in the tank body 30 for installing the holder unit 40 and the pump module 10. The entrance space “Re” is defined as the space in the tank body 30 at the position adjacent to the tank opening 310. It is, therefore, not necessary to pull up the holder unit 40 so as to move and locate the movable end 41 of the holder unit 40 at the position in the entrance space “Re”, when installing the pump module 10 in the tank body 30. In addition, it is possible to easily confirm that the holder unit 40 is not engaged with the holding portion 60, because the movable end 41 of the holder unit 40 is lifted up by the biasing force of the spring 80 to the position of the entrance space “Re” when the holder unit 40 is not surely engaged with the holding portion 60 during the step for installing the pump module 10 in the tank body 30.

In the present embodiment, the tank opening 310 is formed in the top wall 31, which is the upper-side wall of the tank body 30 in the vertical direction. The installation space “Rs” is formed in a predetermined area from the bottom wall 32, which is the lower-side wall of the tank body 30 in the vertical direction. The one end of the spring 80 is connected to the holder unit 40, while the other end of the spring 80 is connected to the bottom wall 32. According to the above structure, it is possible to avoid a situation that the spring 80 interferes with the discharge hose 5 and other parts in the tank body 30, when the pump module 10 is installed and/or operated in the tank body 30.

In addition, in the present embodiment, the fuel supply system 1 is composed of the fuel tank 2, the spring 80, the pump module 10, the sender gage 20 and so on. The spring 80 biases the holder unit 40 in such a way that the movable end 41 of the holder unit 40, which is located at the position opposite to the rotation supporting portion 50, is moved from the installation space “Rs” to the entrance space “Re”. The pump module 10 is accommodated in the tank body 30. The sender gage 20 is composed of the rotation center portion 21 connected to the pump module 10, the arm member 22 extending from the rotation center portion 21 and rotatable around the rotation center portion 21, the float member 23 provided at the end of the arm member 22 opposite to the rotation center portion 21 and generating the buoyant force in the fuel, and the detection unit 24 detecting the rotational position of the arm member 22. The arm member 22 extends from the rotation center portion 21 in the direction opposite to the rotation supporting portion 50, in the condition that the pump module 10 is attached to the holder unit 40 and the holder unit 40 is engaged with the holding portion 60.

According to the above structure, the movable end 41 of the holder unit 40 is moved by the biasing force of the spring 80 to the position separated from the bottom wall 32 by the predetermined distance, when the holder unit 40 is disengaged from the holding portion 60 during the operation of the fuel supply system 1. When the tank body 30 is filled up with the fuel in the above situation (the holder unit 40 is separated from the bottom wall 32), the ECU 4 determines that the tank body 30 is not yet fully filled up with the fuel, because the arm member 22 is located at the rotational position different from the predetermined position corresponding to the fuel filled-up condition of the tank body 30. Accordingly, it is possible to surely detect that the holder unit 40 is disengaged from the holding portion 60.

### Third Embodiment

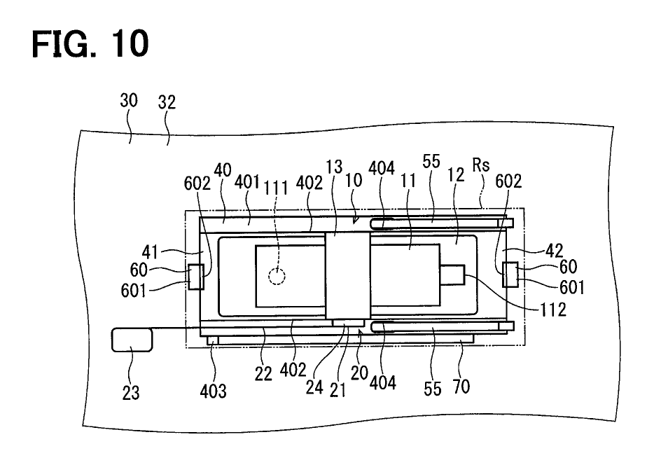

The fuel tank 2 and the fuel supply system 1 according to a third embodiment are shown in FIGS. 10 to 13. The structure of the holder unit 40 of the third embodiment is different from that of the first embodiment.

In the present embodiment, a pair of guide holes 404 is formed in the holder unit 40. Each of the guide holes 404 extends in a thickness direction of the holder body 401. As shown in FIG. 10, each guide hole 404 is formed at a position, which is almost a center of the holder body 401 in the longitudinal direction thereof. More exactly, each guide hole 404 is located at the position between the holder groove 402 and an outer periphery (the right-hand end 42) of the holder body 401 in the longitudinal direction. The guide holes 404 are formed at both sides of the holder body 401 in a short-side direction (perpendicular to the longitudinal direction).

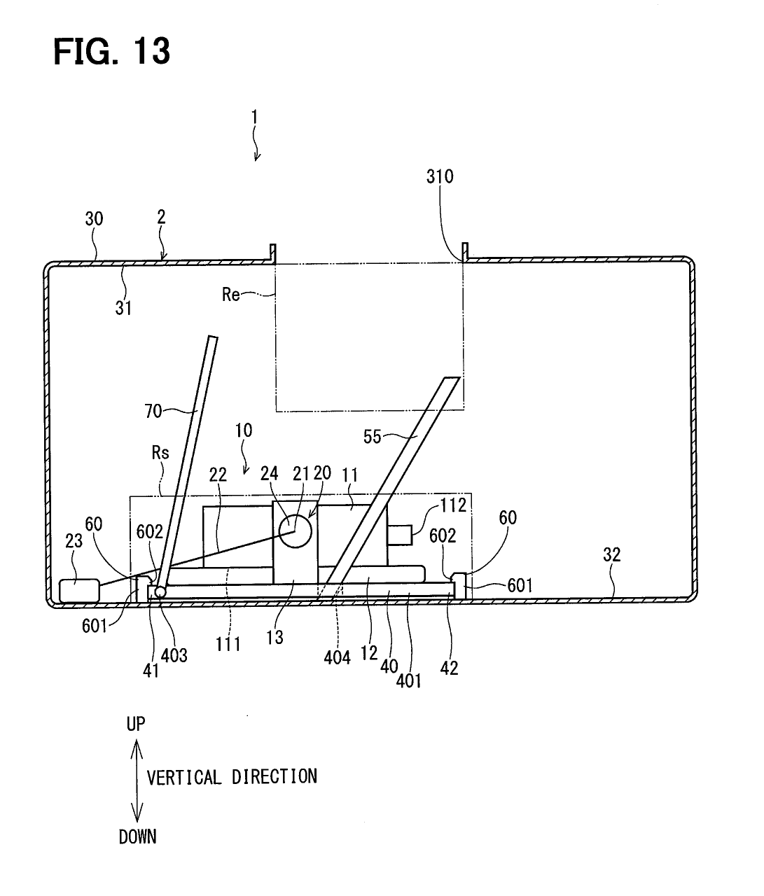

In the present embodiment, the rotation supporting portion 50 of the first embodiment is not provided. In the present embodiment, a pair of the holding portions 60 is provided. In the same manner to the first embodiment, one of the holding portions 60 (a left-hand holding portion 60) is operatively engaged with the left-hand end 41 of the holder body 401. The other holding portion 60 (a right-hand holding portion 60) is likewise operatively engaged with the right-hand end 42 of the holder body 401, as shown in FIGS. 10 and 13.

In the present embodiment, a pair of guide members 55 is provided instead of the rotation supporting portion 50. Each of the guide members 55 is formed in a bar shape and provided in the tank body 30. Each guide member 55 extends from the bottom wall 32 in a direction to the top wall 31 in such a way that the guide member 55 is inclined with respect to the bottom wall 32 and a lower-side end of the guide member 55 is fixed to the bottom 32 at a position which is almost a center between the two holding portions 60 in the longitudinal direction. At least a part of the guide member 55 (that is, an upper-side end) is located in the entrance space “Re”. Each guide member 55 is inserted through each of the guide holes 404 of the holder body 401, so that the holder unit 40 is movable along the guide members 55. The guide members 55 guide the holder unit 40 from a position in the entrance space “Re” to a position in the installation space “Rs”, in a condition that each of the guide members 55 is movably engaged with the corresponding guide hole 404. Since the guide members 55 are inclined with respect to the bottom wall 32, the holder unit 40 is moved in an inclined direction from the entrance space “Re” to the installation space “Rs”, or vice versa. In the present embodiment, the installation space “Rs” is located at a position not directly below the tank opening 310 but displaced in the left-hand direction by a predetermined distance.

(Step for pulling up the holder unit)

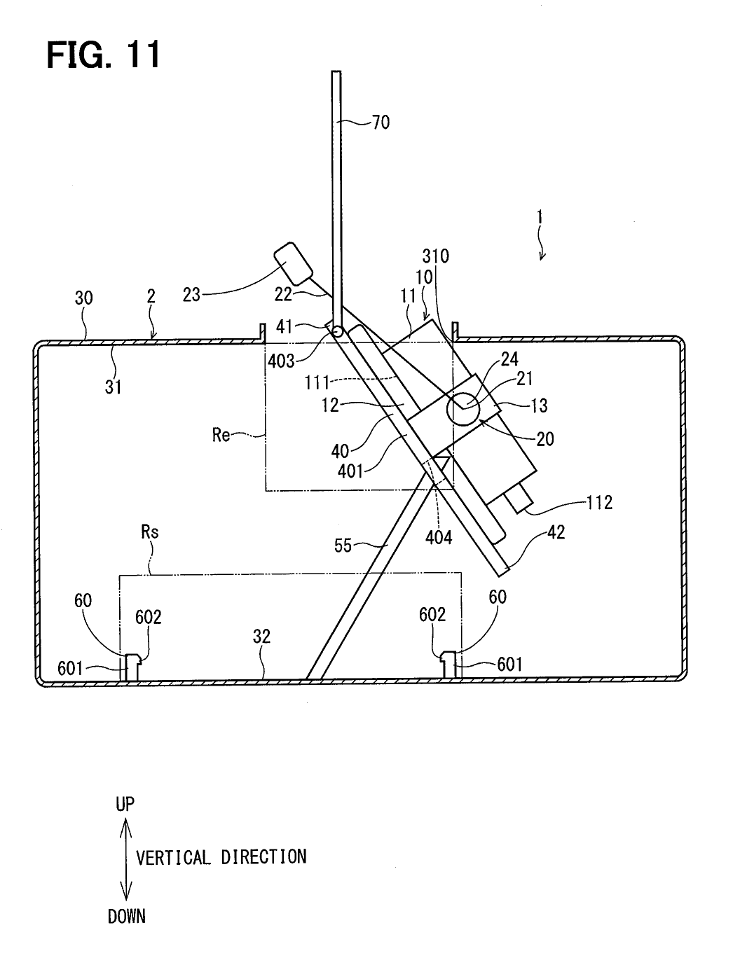

As shown in FIG. 11, the grip end of the manual lever 70 is caught by the worker and the left-hand end 41 of the holder unit 40 is pulled up in the vertical direction. The holder unit 40 is thereby pulled up in the direction from the installation space “Rs” to the entrance space “Re”, while the guide members 55 are engaged with the guide holes 404 so that the holder unit 40 is guided along the guide members 55. The left-hand end 41 of the holder unit 40 as well as other parts of the holder unit 40 neighboring to the left-hand end 41 is located in the entrance space “Re”. The holder unit 40 is located in the tank body 30 in an inclined condition with respect to the bottom wall 32.

(Step for attaching the pump module to the holder unit)

As shown in FIG. 11, the fitting projections 131 (FIG. 3) of the pump module 10 are inserted into the holder grooves 402 (FIG. 2) of the holder unit 40 in order to attach the pump module 10 to the holder unit 40, while the holder grooves 402 are visually confirmed by the worker through the tank opening 310. Then, the pump module 10 is moved by the worker to the predetermined position of the holder unit 40 in the direction of the holder grooves 402, in the condition that the fitting projections 131 are inserted into the holder grooves 402. As a result, the pump module 10 is fixed to the predetermined position of the holder unit 40.

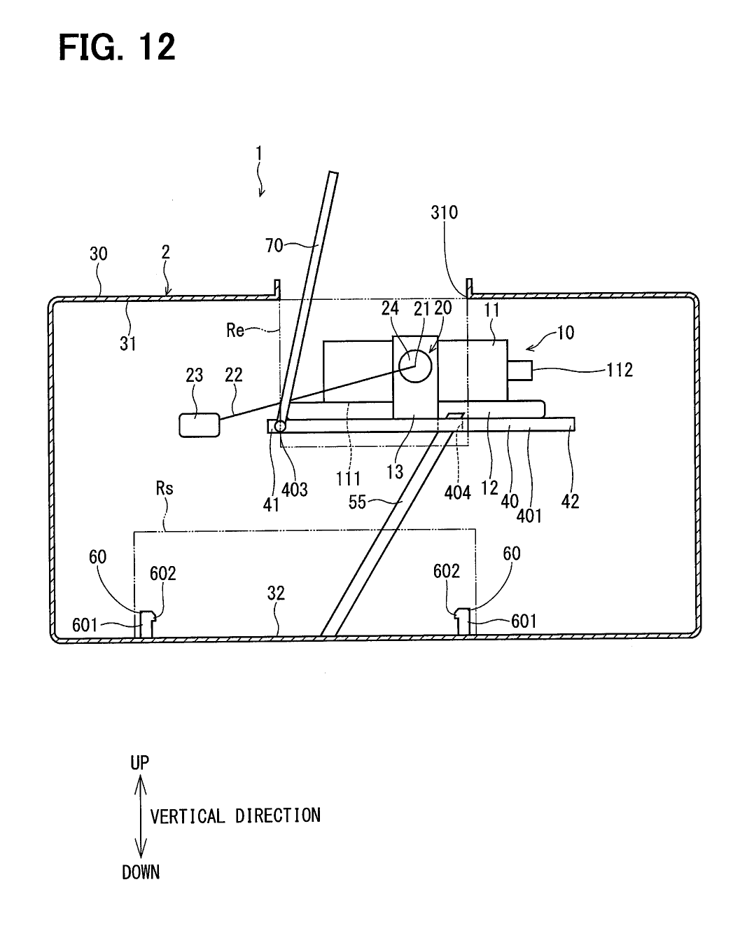

As shown in FIGS. 11 and 12, the holder unit 40 is moved by the worker in such a way that the left-hand end 41 of the holder unit 40 is rotated so as to come closer to the bottom wall 32 (in the anti-clockwise direction in FIG. 11) and that the inclined condition of the holder unit 40 is changed to a position parallel to the bottom wall 32 (FIG. 12). Then, the holder unit 40 is further moved from the position of FIG. 12 to a position of FIG. 13. The holder unit 40 is guided by the guide members 55 in such a way that the guide members 55 are engaged with the guide holes 404 and the holder unit 40 is moved along the guide members 55 from the entrance space “Re” to the installation space “Rs”. As a result, each of the left-hand and the right-hand ends 41 and 42 of the holder unit 40 is engaged with the respective holding portions 60 (FIG. 13). The holder unit 40 and the pump module 10 are located in the installation space “Rs”. If the manual lever 70 can be pulled up in the vertical direction with a small force, the worker can confirm that the holder unit 40 is not surely engaged with the holding portions 60.

As explained above, the guide members 55 are provided in the present embodiment. The guide members 55 are engaged with the guide holes 404 of the holder unit 40 in order to guide the holder unit 40 from the entrance space “Re”, which is formed in the tank body 30 at the position adjacent to the tank opening 310, to the installation space “Rs”, which is formed in the tank body 30 for installing the holder unit 40 and the pump module 10. According to the above structure, it is possible to smoothly move the holder unit 40 from the entrance space “Re” to the installation space “Rs”. In other words, it is possible to easily install the pump module 10 in the tank body 30 at the position within the installation space “Rs”.

In addition, in the present embodiment, the tank opening 310 is formed in the top wall 31, which is formed at the upper side of the tank body 30. The installation space “Rs” is formed at the position within a predetermined space of the tank body 30 from the bottom wall 32, which is formed at the lower side of the tank body 30. The guide members 55 guide the movement of the holder unit 40 in such a way that the holder unit 40 is moved in the direction inclined with respect to the bottom wall 32. Therefore, it is possible to locate the installation space “Rs” at the position, which is displaced from the position directly below the tank opening 310 by the predetermined distance. In other words, design flexibility is increased for the location of the installation space “Rs”, that is, the location of the pump module 10.

### Fourth Embodiment

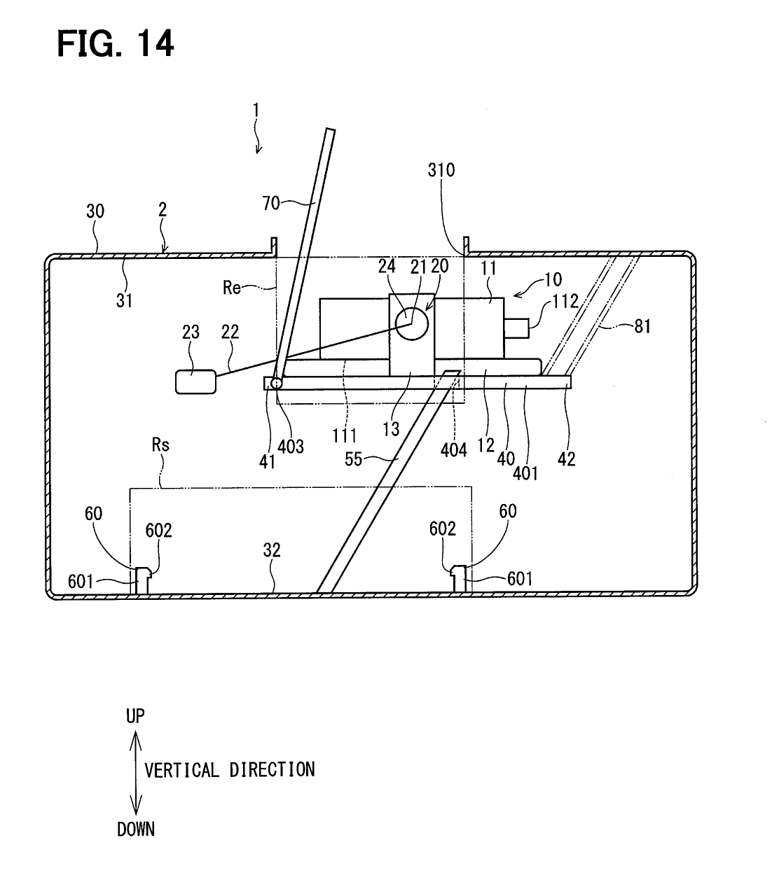

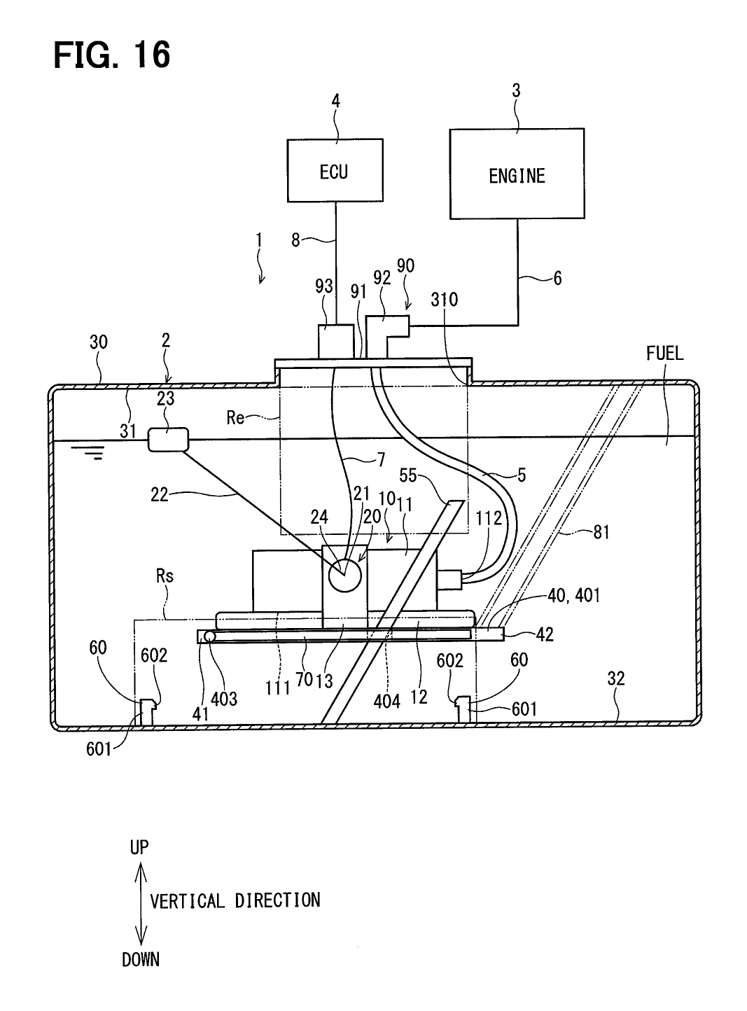

The fuel tank 2 and the fuel supply system 1 according to a fourth embodiment are shown in FIGS. 14 to 16. The fourth embodiment is different from the third embodiment in that a biasing member is provided in the fourth embodiment.

In the present embodiment, a spring 81 is provided as the biasing member. The spring 81 is composed of, for example, a coil spring. One end of the spring 81 is connected to an upper side of the right-hand end 42 of the holder body 401, while the other end of the spring 81 is fixed to the top wall 31. The spring 81 has a compression force, so that the spring biases the holder unit 40 in an upward direction to the top wall 31. More exactly, the spring 81 biases the holder unit 40 in the direction that the left-hand end 41 of the holder unit 40 is moved from the installation space “Rs” to the entrance space “Re”. Therefore, the left-hand end 41 of the holder unit 40 is located in the entrance space “Re”, when the holder unit 40 is not engaged with the holding portions 60, as shown in FIG. 14.

A step for installing the pump module 10 into the tank body 30 will be explained.

(Step for attaching the pump module to the holder unit)

In the same manner to that of the first embodiment, the pump module 10 is attached to the holder unit 40. More exactly, the fitting projections 131 (FIG. 3) of the pump module 10 are inserted into the holder grooves 402 (FIG. 10) of the holder unit 40 in order to attach the pump module 10 to the holder unit 40, while the holder grooves 402 are visually confirmed by the worker through the tank opening 310. As a result, the pump module 10 is fixed to the predetermined position of the holder unit 40, as shown in FIG. 14.

(Step for moving the holder unit & Step for fitting the holder unit to the tank body)

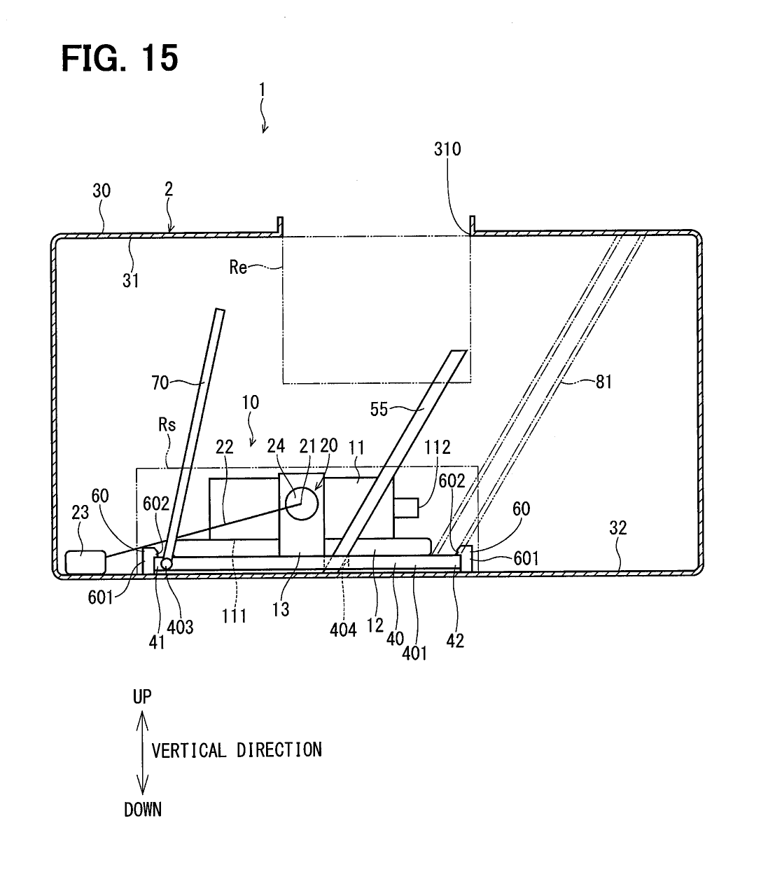

As shown in FIGS. 14 and 15, the holder unit 40 is pushed down by the manual lever 70 against a biasing force of the spring 81, so that the holder unit 40 is moved in the direction to the bottom wall 32. The holder unit 40 is thereby engaged with the holding portions 60, as shown in FIG. 15. In the condition of FIG. 15, the holder unit 40 and the pump module 10 are located in the installation space “Rs”. It can be confirmed by the worker whether the holder unit 40 is surely engaged with the holding portions 60 or not. If the holder unit 40 returns to the position of FIG. 14, it indicates to the worker that the holder unit 40 is not surely engaged with or disengaged from the holding portions 60.

In the present embodiment, the left-hand end 41 of the holder unit 40 is located in the entrance space “Re” by the biasing force of the spring 81, when the holder unit 40 is not engaged with the holding portions 60. Therefore, the step for pulling up the holder unit 40, which is carried out in the third embodiment, is not necessary in the present embodiment.

In addition, the holder unit 40 is moved by the biasing force of the spring 81 in the direction from the bottom wall 32 to the tank opening 310 and located at such a position separated from the bottom wall 32 by a predetermined distance, if the holder unit 40 is disengaged from the holding portions 60 during the operation of the fuel supply system 1. When the tank body 30 is filled up with the fuel in the above situation (the holder unit 40 is separated from the bottom wall 32), the ECU 4 determines that the tank body 30 is not yet filled up with the fuel in spite that the tank body 30 is fully filled up with the fuel, because the arm member 22 is located at the rotational position different from the predetermined position corresponding to the fuel filled-up condition of the tank body 30. Accordingly, it is possible to detect that the holder unit 40 is disengaged from the holding portions 60.

As explained above, in the present embodiment, the tank opening 310 is formed in the top wall 31, which is formed at the upper side of the tank body 30. The installation space “Rs” is formed at the position within the predetermined space of the tank body 30 from the bottom wall 32, which is formed at the lower side of the tank body 30. One end of the spring 81 is connected to the holder unit 40, while the other end of the spring 81 is fixed to the top wall 31. As a result, it is possible to locate the holder unit 40 at the position closer to the bottom wall 32, when compared with a case in which the spring is provided between the holder unit 40 and the bottom wall 32.

### Fifth Embodiment

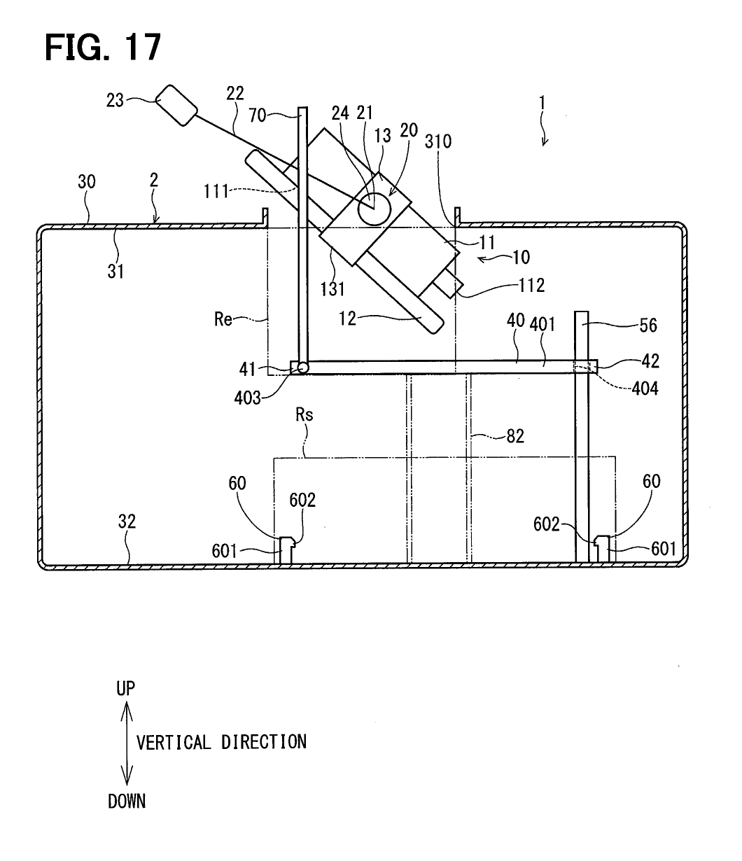

The fuel tank 2 and the fuel supply system 1 according to a fifth embodiment are shown in FIGS. 17 to 19. The structure of the fifth embodiment for the guide member and the spring is different from that of the fourth embodiment.

In the present embodiment, a pair of guide members 56 is provided in the tank body 30. Each of the guide members 56 is formed in the bar shape. Although only one guide member 56 is shown in the drawings, another guide member 56 is provided at a position behind the one guide member 56 shown in the drawings. Each guide member 56 extends from the bottom wall 32 in the vertical direction to the top wall 31 at a position between the holding portions 60 in the horizontal direction. The guide holes 404 are formed in the holder body 401 of the holder unit 40 at a position close to the right-hand end 42 of the holder body 401. Each of the guide members 56 is inserted through each of the guide holes 404, so that the holder unit 40 is movably engaged with the guide members 56. The holder unit 40 is movable in the vertical direction along the guide members 56 from the entrance space “Re” to the installation space “Rs”. In the present embodiment, the installation space “Rs” is formed at such a position, which is displaced in the right-hand direction from the position directly below the tank opening 310.

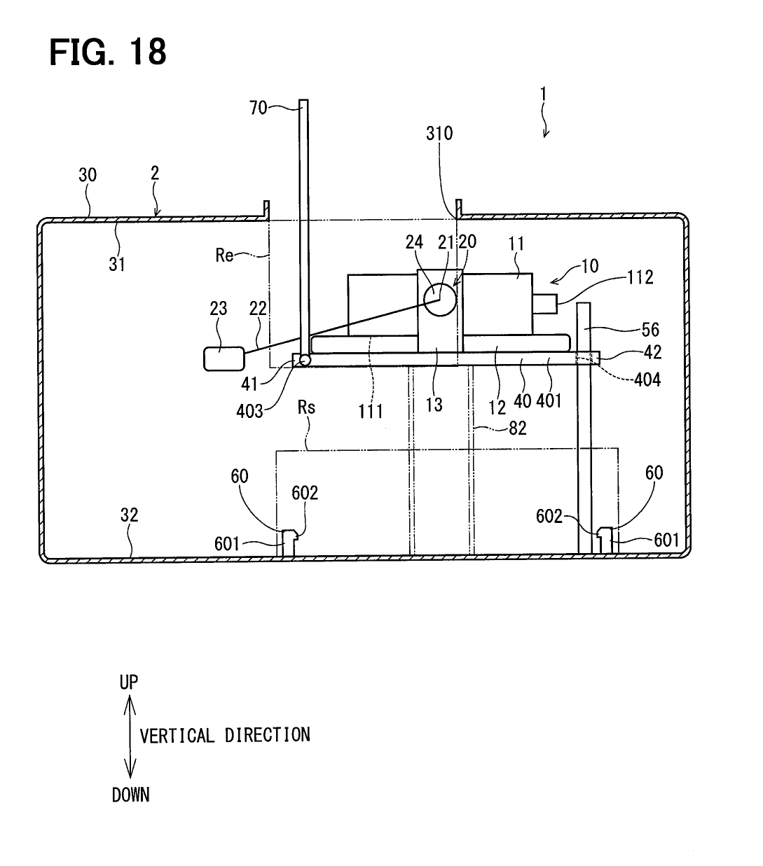

In the present embodiment, a spring 82 is provided as the biasing member. The spring 82 is composed of, for example, a coil spring. One end of the spring 82 is connected to the lower side of the holder body 401, while the other end of the spring 82 is fixed to the bottom wall 32. The spring 82 has an expansion force in its axial direction. The spring 82 biases the holder unit 40 in the direction from the installation space “Rs” to the entrance space “Re”. The left-hand end 41 of the holder unit 40 is located in the entrance space “Re”, when the holder unit 40 is not engaged with the holding portions 60, as shown in FIGS. 17 and 18.

A step for installing the pump module 10 into the tank body 30 will be explained.

(Step for attaching the pump module to the holder unit)

In the same manner to the above embodiments, the pump module 10 is attached to the holder unit 40. More exactly, as shown in FIGS. 17 and 18, the fitting projections 131 of the pump module 10 are inserted into the holder grooves 402 (FIG. 10) of the holder unit 40 in order to attach the pump module 10 to the holder unit 40, while the holder grooves 402 are visually confirmed by the worker through the tank opening 310. As a result, the pump module 10 is fixed to the predetermined position of the holder unit 40, as shown in FIG. 18.

(Step for moving the holder unit & Step for fitting the holder unit to the tank body)

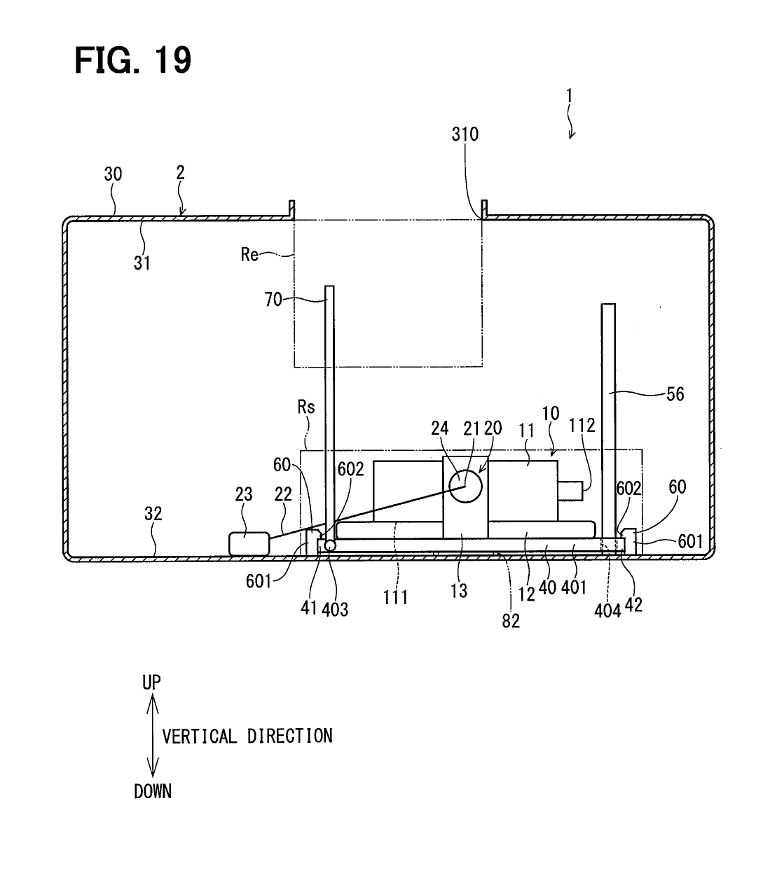

As shown in FIG. 18, the holder unit 40 is pushed down by the manual lever 70 against a biasing force of the spring 82, so that the holder unit 40 is moved in the direction to the bottom wall 32. The holder unit 40 is thereby engaged with the holding portions 60, as shown in FIG. 19. In the condition of FIG. 19, the holder unit 40 and the pump module 10 are located in the installation space “Rs”. The worker can confirm whether the holder unit 40 is surely engaged with the holding portions 60 or not. If the holder unit 40 returns to the position of FIG. 18, it indicates to the worker that the holder unit 40 is disengaged from the holding portions 60.

As explained above, in the present embodiment, the tank opening 310 is formed in the top wall 31, which is formed at the upper side of the tank body 30. The installation space “Rs” is formed at the position within the predetermined space of the tank body 30 from the bottom wall 32, which is formed at the lower side of the tank body 30. The guide members 56 can smoothly guide the movement of the holder unit 40 in the vertical direction. The installation space “Rs” can be formed at the position displaced from the position directly below the tank opening 310 by the predetermined distance. Therefore, it is possible to increase the design flexibility for the position of the pump module 10 in the tank body 30.

### Sixth Embodiment

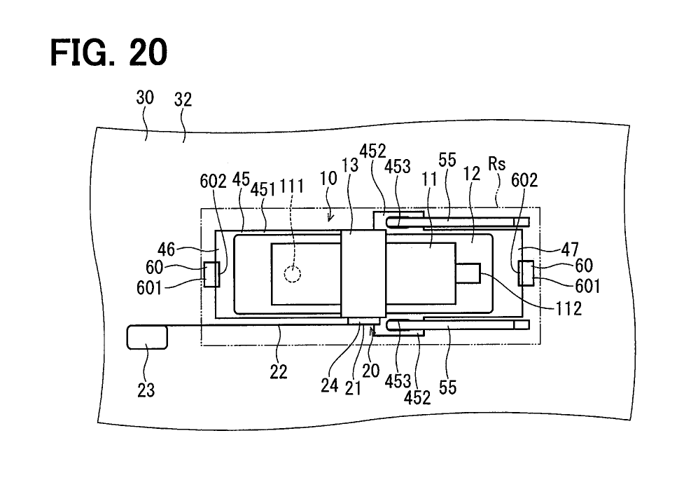

The fuel tank 2 and the fuel supply system 1 according to a sixth embodiment are shown in FIGS. 20 to 23. A structure of the pump module 10 of the sixth embodiment is different from that of the third embodiment (FIGS. 10 to 13).

In the present embodiment, the pump module 10 has a holder unit 45, which is integrally attached to the pump module 10 before installing the pump module 10 in the tank body 30. The holder unit 45 has a holder body 451, a pair of outwardly extending portions 452, a pair of guide holes 453 and so on. The holder body 451 is made of resin and formed in a rectangular plate shape. Each of the outwardly extending portions 452 extends from an almost center portion of a longitudinal side of the holder body 451 in an outward and a short-side direction of the holder body 451, as shown in FIG. 20. Each of the guide holes 453 is formed in each of the outwardly extending portions 452 so as to pass through the same in its thickness direction.

An upper-side surface of the holder unit 45 is in contact with a lower-side surface of the fuel filter 12, which is an opposite side to the fuel pump 11. The pump attaching member 13 firmly connects the fuel pump 11 and the fuel filter 12 to the holder unit 45 so as to make them as one integral unit.

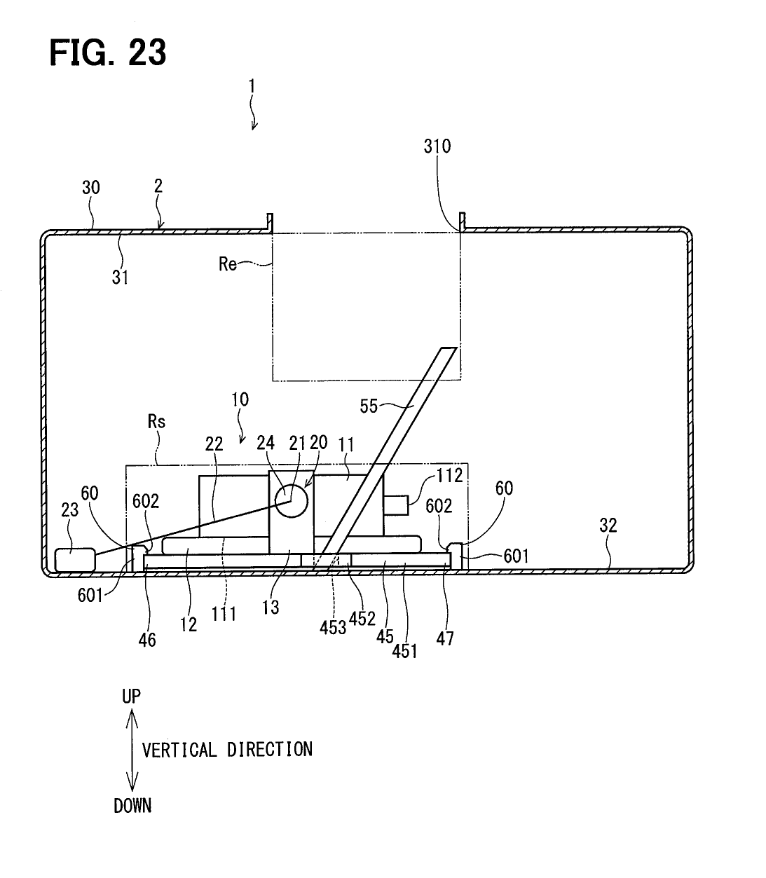

One of the holding portions 60 is provided so as to be engaged with a left-hand end 46 of the holder body 451, while the other holding portion 60 is provided so as to be engaged with a right-hand end 47 of the holder body 451 in the longitudinal direction of the holder unit 45, as shown in FIGS. 20 and 23.

Each of the guide members 55 is respectively inserted into and engaged with each of the guide holes 453 of the holder unit 45. The guide members 55 guide the holder unit 45 from a position in the entrance space “Re” to a position in the installation space “Rs”, in a condition that each of the guide members 55 is movably engaged with the corresponding guide hole 453. Since the guide members 55 are inclined with respect to the bottom wall 32, the holder unit 45 (including the pump module 10) is moved in the inclined direction from the entrance space “Re” to the installation space “Rs”, or vice versa.

A step for installing the pump module 10 into the tank body 30 will be explained.

(Step for engaging the pump module with the guide members)

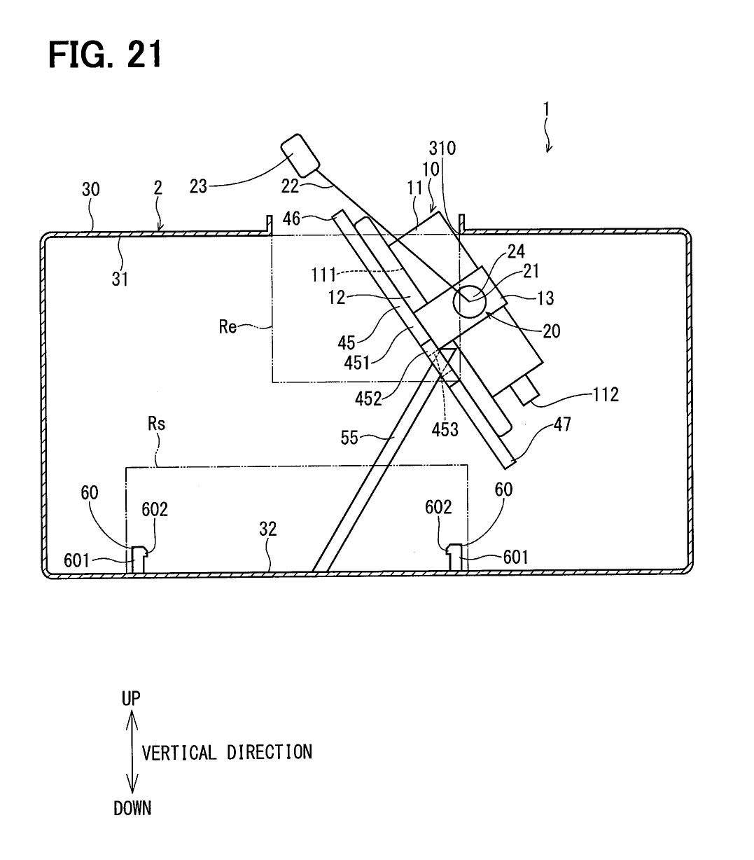

As shown in FIG. 21, the guide members 55 are inserted into the respective guide holes 453 of the pump module 10, more exactly, the guide holes 453 formed in the holder body 451 integrally connected to the pump module 10, while the upper-side ends of the guide members 55 are visually confirmed by the worker through the tank opening 310.

(Step for rotating the holder unit & Step for fitting the holder unit to the tank body)

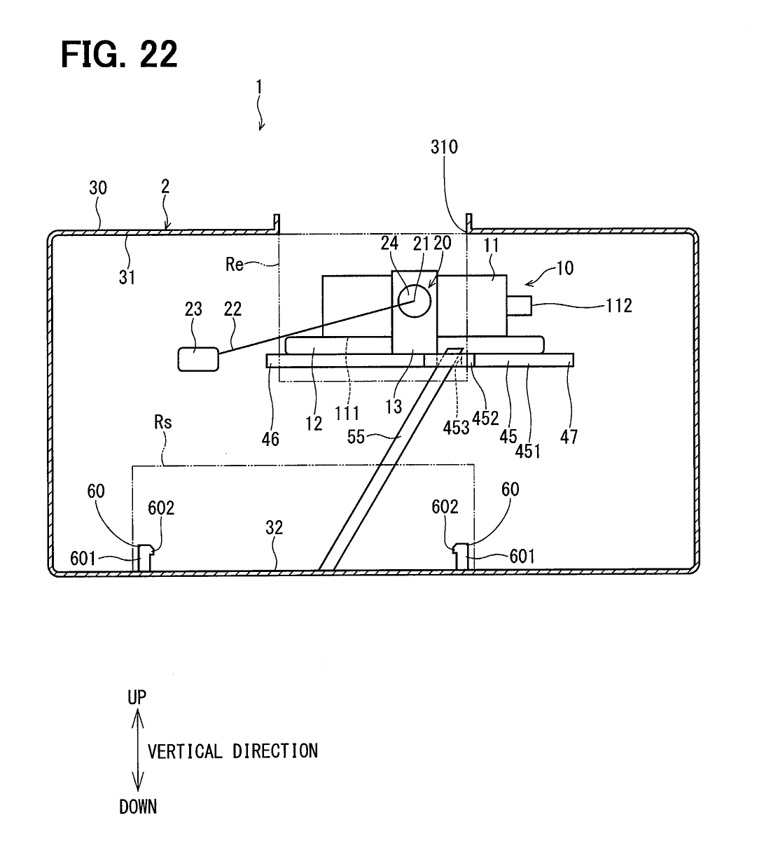

As shown in FIGS. 21 and 22, the holder unit 45 as well as the pump module 10 is rotated by the worker in the direction that the left-hand end 46 of the holder body 451 comes closer to the bottom wall 32, until the holder unit 45 is moved to the position parallel to the bottom wall 32. Then, as shown in FIGS. 22 and 23, the pump module 10 including the holder unit 45 is further moved by the worker in the direction to the bottom wall 32. During the above movement of the pump module 10, the guide members 55 are engaged with the guide holes 453 of the holder unit 45 so that the pump module 10 as well as the holder unit 45 are guided by the guide members 55 from the entrance space “Re” to the installation space “Rs”. As a result, the holder unit 45 is engaged with the holding portions 60, as shown in FIG. 23. In this condition, the pump module 10 including the holder unit 45 is located in the installation space “Rs”.

As explained above, in the present embodiment, the pump module 10 is accommodated in the fuel tank 2, wherein the fuel is discharged by the pump module 10 to the outside of the fuel tank 2. The fuel tank 2 has the tank body 30, the holding portions 60 and the guide members 55. The tank body 30 stores the fuel, accommodates the pump module 10 and has the tank opening 310. The holding portions 60 are provided at the inner wall (the bottom wall 32) of the tank body 30, so that the holding portions 60 are engaged with the holder unit 45 so as to firmly hold the pump module 10. It is, therefore, possible to stabilize the position of the pump module 10 in the tank body 30.

The guide members 55 are provided in the tank body 30 and inserted into the guide holes 453 of the pump module 10 so as to guide the movement of the pump module 10 in the tank body 30. In the present embodiment, the upper-side end of the guide member 55 is located at the position in the entrance space “Re”, which is formed adjacent to the tank opening 310. It is, therefore, possible to easily and visually confirm the position of the guide members 55 through the tank opening 310. In other words, it is possible to easily engage the pump module 10 with the guide members 55. It is thereby possible to install the pump module 10 to the predetermined position (the installation space “Rs”) of the tank body 30, when the pump module 10 is moved along the guide members 55 and the pump module 10 is engaged with the holding portions 60. As above, it is possible to easily install the pump module 10 in the tank body 30.

### Seventh Embodiment

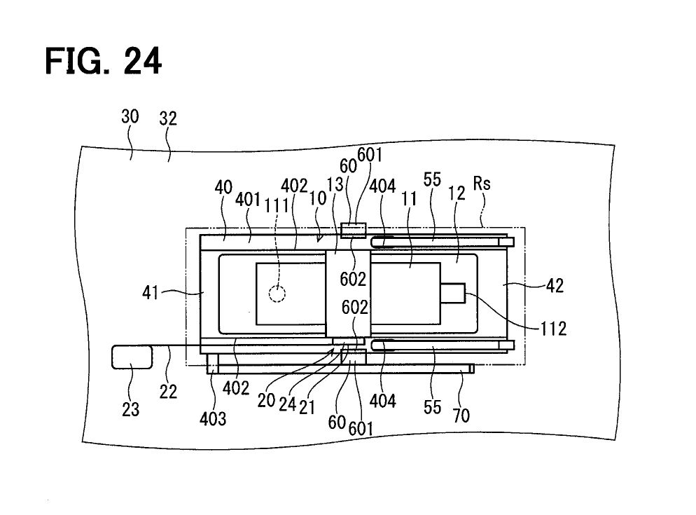

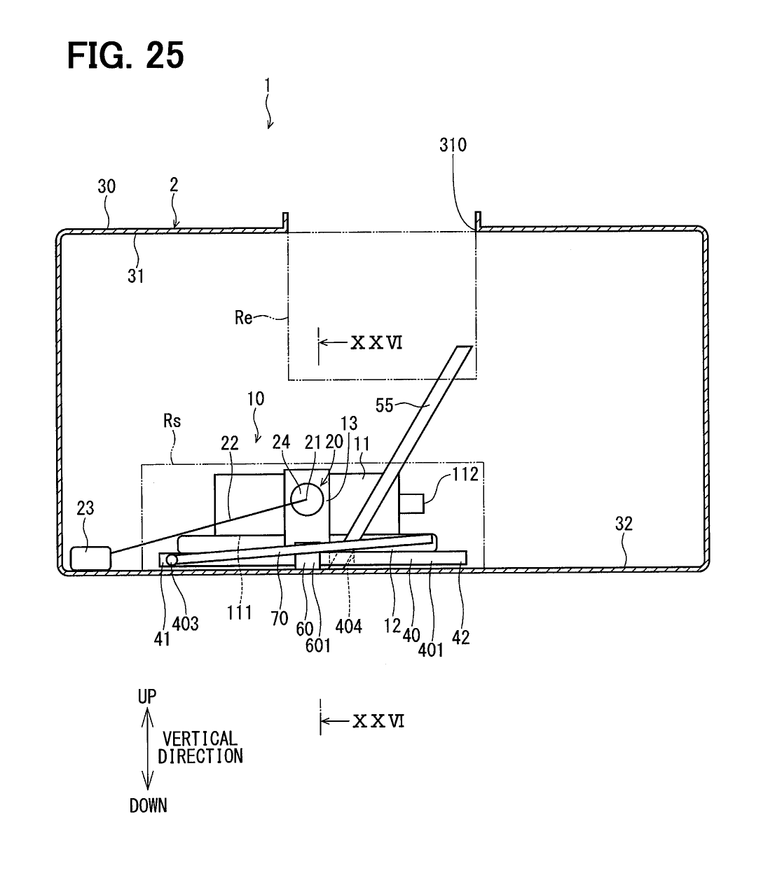

The fuel tank 2 and the fuel supply system 1 according to a seventh embodiment are shown in FIGS. 24 to 26. A position and a structure of the holding portions 60 of the seventh embodiment are different from those of the third embodiment (FIGS. 10 to 13).

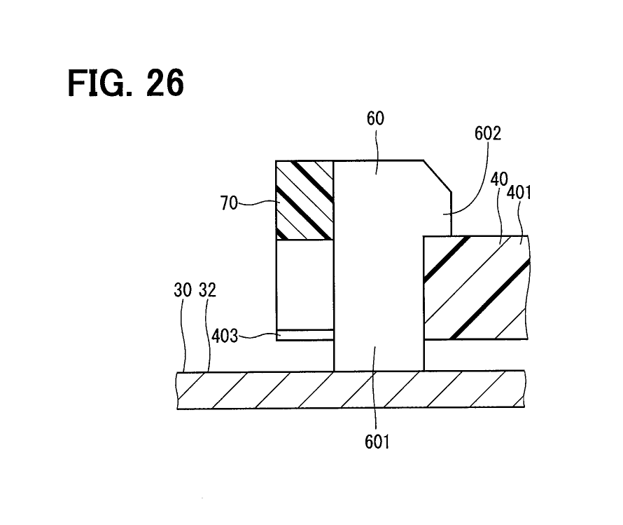

In the present embodiment, the holding portions 60 are arranged not in the longitudinal direction but in the short-side direction (perpendicular to the longitudinal direction), as shown in FIG. 24. The manual lever 70 is rotatable around the rotation supporting projection 403. The manual lever 70 is held at its initial position, in which an axial direction of the manual lever 70 is almost parallel to the longitudinal direction of the holder body 401. As shown in FIG. 26, the manual lever 70 is in contact with an outside surface of the supporting body 601 of the holding portion 60, which is on an opposite side to the fitting claw 602, when the manual lever 70 is in the initial position. The manual lever 70 prevents the supporting body 601 from being deformed or inclined in a direction away from the holder body 401 of the holder unit 40. In other words, it is possible to prevent the fitting claw 602 from being disengaged from the holder unit 40.

### Eighth Embodiment

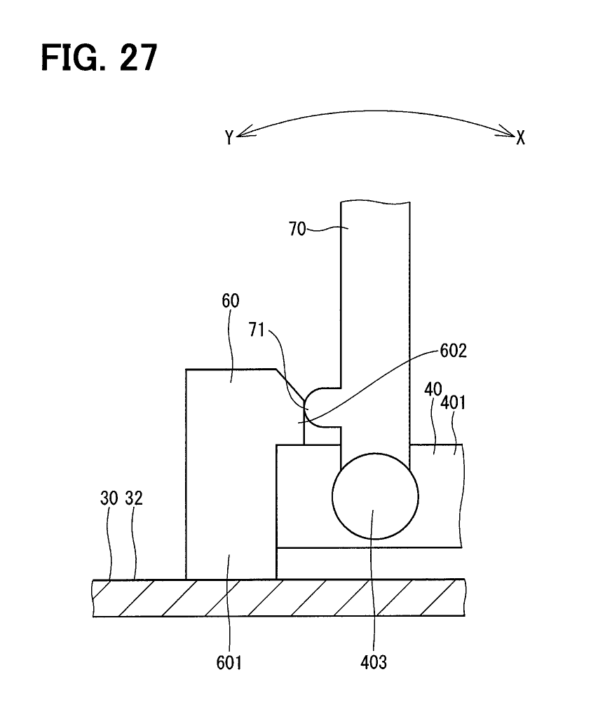

A part of the fuel tank and the fuel supply system according to an eighth embodiment is shown in FIG. 27. A position of the holding portion 60 and a structure of the manual lever 70 of the eighth embodiment are different from those of the first embodiment.

In the first embodiment, the holding portion 60 is located at the position, which is a center of the left-hand side of the holder body 401 in the short-side direction, as shown in FIG. 2. According to the present embodiment, the holding portion 60 is located at a position, which is close to a corner of the left-hand side of the holder body 401 and close to the rotation supporting projection 403 for the manual lever 70. In the present embodiment, a projection 71 is formed in the manual lever 70 in such a way that the projection 71 is projected from a portion of the manual lever 70 close to the rotation supporting projection 403 in a direction to the fitting claw 602 of the holding portion 60, in a condition that the manual lever 70 extends from the rotation supporting projection 403 in the vertical direction. The projection 71 is in contact with a forward end surface of the fitting claw 602. When the manual lever 70 is rotated in a direction “Y”, which is opposite to a direction “X” for moving the manual lever 70 to the initial position, the fitting claw 602 is pushed back by the projection 71 in the left-hand direction. A top end of the supporting body 601 is thereby deformed in a direction away from the holder unit 40, so that the fitting claw 602 is disengaged from the holder body 401 and thereby the holder unit 40 is disengaged from the holding portion 60.

As explained above, in the present embodiment, the manual lever 70 has the projection 71, with which the holder unit 40 can be easily disengaged from the holding portion 60. It is, therefore, to easily disengage the holder unit 40 from the holding portion 60 after they are engaged with each other.

### Further Embodiments and/or Modifications

In the above embodiments, the holding portion 60 is engaged with the holder unit 40 or with the holder unit 45 firmly fixed to the pump module 10 in advance. However, the holding portion 60 may be directly engaged with the pump module.

In the above embodiments including the first embodiment, one end of the manual lever 70 is rotatably connected to the holder unit 40. However, it is not always necessary that the manual lever 70 is rotatably connected to the holder unit 40. In other words, the manual lever 70 may be firmly connected to the holder unit 40. In the case of the sixth embodiment (FIGS. 21 to 23), the manual lever 70 maybe firmly connected to the holder unit 45 which is integrally connected to the pump module 10 as one unit. Furthermore, it is not always necessary to provide the manual lever 70 itself.

In the above second and fifth embodiments (FIGS. 7 to 9 and (FIGS. 17 to 19), the spring 80 or 82 is provided as the biasing member between the almost center portion of the holder unit 40 and the bottom wall 32.

However, the spring may be provided between the left-hand end 41 of the holder body 401 and the bottom wall 32.

In the above embodiments, the tank body 30 is made of the metal. However, it is not always necessary to make the tank body 30 of the metal. For example, the tank body 30 may be made of resin.

In the above embodiments, the holder body 401 or 451 is made of the resin. However, the holder body may be made of metal.

In the above embodiment, the holding portions 60 may be made of any material including the metal, the resin and so on. In addition, the holding portions 60 may be made of either the material, which is the same to or different from that of the tank body 30.

In the above embodiments, the sender gage 20 is provided. However, it is not always necessary to provide the sender gage.

The fuel supply system 1 and/or the fuel tank 2 may be applied not only to the automotive vehicle but also to any other vehicles including ships, air planes and so on.

As above, the present disclosure is not limited to the above embodiments and/or modifications, but can be further modified in various manners without departing from a spirit of the present disclosure.

What is claimed is:

1. A fuel tank for accommodating a pump module and storing fuel to be discharged by the pump module to an outside of the fuel tank comprising;
a tank body for accommodating therein the pump module and storing the fuel therein, the tank body having a tank opening;
a holder unit provided in the tank body, to which the pump module is attached; and
a holding portion formed at an inner wall of the tank body and operatively engaged with the pump module and/or the holder unit so as to hold the pump module at a predetermined position in the tank body,
wherein the holder unit is movably provided in the tank body.

2. The fuel tank according to claim 1, further comprising;
a rotation supporting portion provided in the tank body at a position adjacent to one of longitudinal ends of the holder unit,
wherein the rotation supporting portion movably supports the holder unit, and
a movable end of the holder unit, which is formed at a longitudinal end opposite to the rotation supporting portion, is located in an entrance space formed in the tank body at a position adjacent to the tank opening, when the holder unit is rotated around the rotation supporting portion.

3. The fuel tank according to claim 1, further comprising;
a guide member provided in the tank body in such a way that the guide member is movably engaged with the pump module or the holder unit,
wherein the pump module or the holder unit, which is engaged with the guide member, is movable along the guide member from a position of an entrance space to a position of an installation space, or vice versa,
wherein the entrance space is formed in the tank body at a position adjacent to the tank opening, and
wherein the installation space is formed in the tank body at a position, which is defined as a position for installing the pump module and the holder unit in the tank body.

4. The fuel tank according to claim 3, wherein
the tank opening is formed in a top wall of the tank body, which is an upper-side wall in a vertical direction of the tank body,
the installation space is formed in a predetermined area from a bottom wall of the tank body, which is a lower-side wall in the vertical direction, and
the guide member is inclined with the bottom wall so as to guide the holder unit in a direction inclined with the bottom wall.

5. The fuel tank according to claim 3, wherein
the tank opening is formed in a top wall of the tank body, which is an upper-side wall in a vertical direction of the tank body,
the installation space is formed in a predetermined area from a bottom wall of the tank body, which is a lower-side wall in the vertical direction, and
the guide member is perpendicular to the bottom wall so as to guide the holder unit in a direction perpendicular to the bottom wall.

6. The fuel tank according to claim 1, further comprising;
a biasing member for biasing the holder unit in such a direction that at least a portion of the holder unit is moved from a position of an installation space to a position of an entrance space,
wherein the entrance space is formed in the tank body at a position adjacent to the tank opening, and
wherein the installation space is formed in the tank body at a position, which is defined as a position for installing the pump module and the holder unit in the tank body.

7. The fuel tank according to claim 6, wherein
the tank opening is formed in a top wall of the tank body, which is an upper-side wall in a vertical direction of the tank body,
the installation space is formed in a predetermined area from a bottom wall of the tank body, which is a lower-side wall in the vertical direction, and
one end of the biasing member is connected to the holder unit, while the other end of the biasing member is connected to the bottom wall.

8. The fuel tank according to claim 6, wherein
the tank opening is formed in a top wall of the tank body, which is an upper-side wall in a vertical direction of the tank body,
the installation space is formed in a predetermined area from a bottom wall of the tank body, which is a lower-side wall in the vertical direction, and
one end of the biasing member is connected to the holder unit, while the other end of the biasing member is connected to the top wall.

9. The fuel tank according to claim 1, further comprising;
a manual lever, one end of which is connected to the holder unit,
wherein the other end of the manual lever works as a grip end which is operatively located at a position adjacent to the tank opening, in a condition that the holder unit and the pump module are located in an installation space, and
wherein the installation space is formed in the tank body at a position, which is defined as a position for installing the pump module and the holder unit in the tank body.

10. The fuel tank according to claim 9, wherein
the manual lever is rotatable around the one end of the manual lever, at which the manual lever is movably connected to the holder unit.

11. The fuel tank according to claim 9, wherein
the manual lever has a projection, which operatively disengages the holding portion from the holder unit or the pump module.

12. A fuel tank for accommodating a pump module and storing fuel to be discharged by the pump module to an outside of the fuel tank comprising;
a tank body for accommodating therein the pump module and storing the fuel therein, the tank body having a tank opening;
a holding portion formed at an inner wall of the tank body and operatively engaged with the pump module so as to hold the pump module at a predetermined position in the tank body; and
a guide member provided in the tank body and movably engaged with the pump module in order to guide a movement of the pump module.

13. A fuel supply system comprising;
the fuel tank according to claim 1; and
the pump module provided in the tank body of the fuel tank.

14. The fuel supply system according to claim 13 further comprising;
a sender gage which includes;
a rotation center portion provided in the pump module;
an arm member movably connected to the rotation center portion and extending from the rotation center portion, so that the arm member is rotatable around the rotation center portion;
a float member provided at an end of the arm member on an opposite side to the rotation center portion and generating a buoyant force in the fuel; and
a detection unit for detecting a rotational position of the arm member.

15. A fuel supply system comprising;
the fuel tank according to claim 2;
a biasing member for biasing the holder unit in such a way that the movable end of the holder unit is moved from a position of an installation space to a position of an entrance space, wherein the installation space is formed in the tank body at a position which is defined as a position for installing the pump module and the holder unit in the tank body, and the entrance space is formed in the tank body at a position adjacent to the tank opening;
a sender gage which includes;
a rotation center portion provided in the pump module;
an arm member movably connected to the rotation center portion and extending from the rotation center portion, so that the arm member is rotatable around the rotation center portion;
a float member provided at an end of the arm member on an opposite side to the rotation center portion and generating a buoyant force in the fuel; and
a detection unit for detecting a rotational position of the arm member,
wherein the arm member extends from the rotation center portion in a direction opposite to the rotation supporting portion, in a condition that the pump module is attached to the holder unit and the holder unit is engaged with the holding portion.
